(19) United States
(12) Patent Application Publication
(10) Pub. No.: US 2006/0173088 A1
(43) Pub. Date: Aug. 3, 2006

(54) Method for production of water-soluble porous polymer and water-soluble porous polymer

(76) Inventors: Shigeyuki Nozaki, Yokohama-shi (JP); Daisuke Imai, Osaka (JP); Satoshi Yamada, Osaka (JP); Shuichi Toriya, Osaka (JP); Hidekazu Kozuki, Hyogo (JP); Masaru Ishikawa, Hyogo (JP)

Correspondence Address: FISH & RICHARDSON PC, P.O. BOX 1022, MINNEAPOLIS, MN, 55440-1022, US

(21) Appl. No.: 10/564,052

(22) PCT Filed: Jul. 16, 2004
(86) PCT No.: PCT/JP04/10544

§ 371 Date: Jan. 9, 2006

(30) Foreign Application Priority Data
Jul. 18, 2003 (JP) 2003-277023

(51) Int. Cl. C08J 9/00

(52) U.S. Cl. 521/99

(57) ABSTRACT

A method for efficient production of a water-soluble porous polymer and a water-soluble porous polymer excelling in solubility in water are provided. A method for the production of the polymer is characterized by the fact that an aqueous monomer solution containing an ethylenically unsaturated monomer is polymerized while it is containing bubbles therein. The method can simplify the drying and crushing steps and the water-soluble porous polymer consequently obtained excels in solubility in water.

### TECHNICAL FIELD

This invention relates to a method for the production of a water-soluble porous polymer. More particularly, it relates to a method for producing a water-soluble porous polymer by polymerizing an aqueous polymer solution containing an ethylenically unsaturated monomer while causing the aqueous solution to contain bubbles therein and a water-soluble porous polymer having a void ratio in the range of 5-80% and a water-insoluble content of not more than 10 wt. %.

### BACKGROUND ART

The water-soluble polymers have hitherto come in various kinds of products such as natural macromolecules like gelatin and polysaccharides and synthetic polymers like polyacrylic acid, poly(2-hydroxyethyl methacrylate), polyacrylamide, and polyvinyl alcohol. They are extensively utilized as medical accessories including laceration dressing agents, contact lenses, artificial muscles, and artificial organs, breeding materials including planting materials and artificial planting soils, and tackifiers, waste water cleaning agents, dispersants, pigments, and organism immobilizing carriers. In consequence of the growth of the demand for water-soluble polymers, the desirability of developing a technique for attaining quantity production of a water-soluble polymer inexpensively has been finding popular approval.

It has been known to obtain a polymer by irradiating an acrylic monomer with a light energy. As a means to produce an acrylic polymer gel continuously, a method for continuously producing a polymer gel by adjusting a monomer solution containing an acrylic type monomer and a photopolymerization initiator to an oxygen concentration of not more than 1 mg/l, then delivering the monomer solution in the shape of a thin layer, and irradiating the thin film with a light energy thereby polymerizing the monomer solution has been known (JP-A-1989-138210). To produce the polymer of fine quality stably, this method is required to control the layer of the gel during the stage of polymerization to a fixed thickness. When the gel has a high acrylic acid concentration, it is caused by the heat of polymerization during the polymerization to assume a bumping state consequently suffer loss of the uniformly concentration of itself and induce dispersion of the degree of polymerization and the bumping possibly scatters the monomer. In consideration of this disadvantage, the practice of preparing the aqueous solution having a monomer content in the range of 20-80 wt. % and, with a further view to precluding occurrence of an unpolymerized moiety, imparting to the aqueous solution an oxygen concentration of not more than 1 mg/l and delivering the aqueous solution in a layer thickness in the range of 3-20 mm has been prevailing. The polymer gel at the age of 180 minutes after the start of the delivery of the solution of the monomer mixture has a solids content of 40.8%. The ribbon of the polymer gel consequently obtained is disintegrated into the shape of chips or grains, pulverized with a pulverizer into particles about 3 mm in diameter, and then dried at 80° C. for about one hour.

As a means to produce a low molecular weight water-soluble polymer, a method which produces a low molecular weight water-soluble polymer by photopolymerizing a vinyl type monomer in an aqueous solution thereof in the presence of a hydrogen sulfite ion and a photopolymerization initiator has been known (JP-A-2002-69104). In contrast with the conventional method which obtains a water-soluble polymer of a high molecular weight useful as macromolecular flocculating agents by delivering an aqueous monomer solution of a high concentration in the shape of a thin layer and irradiating the thin layer with an ultraviolet light emitted from above, the present method has been developed for the purpose of producing a water-soluble polymer having a sharp molecular weight distribution and it produces a water-soluble polymer having a weight average molecular weight in the range of 2,000-10,000 by adding 5-85 wt. % of an aqueous vinyl type monomer solution, a hydrogen sulfite ion as a chain transfer agent, and a photopolymerization initiator together, and polymerizing the resultant reaction solution while stirring it. In the working examples, the solids contents indicated were in the range of 36-44 wt. %.

For the purpose of producing a partially neutralized (meth)acrylic acid type polymer manifesting a specific intrinsic viscosity at 30° C. and a specific insoluble content in deionized water, a method for the production of a partially neutralized (meth)acrylic acid type polymer, characterized by polymerizing a monomer component containing as main components an acid type monomer and a (meth)acrylate treated with activated carbon has been disclosed (JP-A-2000-212222). This invention, in view of the fact that the conventional product has no satisfactory degree of polymerization and is incapable of forming a medium possessing hardness and viscosity, is aimed at producing a partially neutralized (meth)acrylic type polymer having a high degree of polymerization.

Since a water-soluble monomer is used for the production of a water-soluble polymer, the reaction solution is automatically an aqueous solution. After the production of the water-soluble polymer, therefore, it is necessary that the water used for the reaction solution be separated from the polymer and that the reaction product be dried. Further, it occurs at times that the water-soluble polymer thus produced is disintegrated and pulverized to suit the purpose of use and the efficiency of disintegrating or pulverization is varied as well by the water content of the polymer. Particularly in the continuous production of the water-soluble polymer, the drying step calls for a long time when the continuous operation is carried out in concert with the speed of the polymerization. For the sake of expediting the drying treatment, the treatment is required to be effected at an elevated temperature, with the result that the thermal energy will be unduly increased and the cost of production will be consequently boosted. Particularly when the water-soluble polymer forms the target for the drying treatment, it is not easily dried on account of its quality. The simplification of such a drying step of the water-soluble polymer, therefore, constitutes an important element responsible for enhancing the efficiency of production and lowering the cost of production.

In the light of the true state of affairs, this invention is aimed at providing a method for producing a water-soluble polymer by a simple procedure at a low cost.

### DISCLOSURE OF THE INVENTION

The present inventor has found that the polymerization of an aqueous monomer solution containing an ethylenically unsaturated monomer, when effected while positively supplying bubbles into the reaction solution, is enabled to produce a water-soluble porous polymer, that the polymer acquires an enlarged surface area and therefore facilitates dissipation of the water and the heat of polymerization entrapped therein, curtails the time required for drying, enhances the efficiency of pulverization at the subsequent step of pulverization, and lowers the cost of production, that the water-soluble porous polymer, even when sliced and pulverized, is capable of manifesting the same degree of viscosity as a non-porous polymer, and that the water-soluble porous polymer has a smaller residual monomer content than the unfoamed polymer, permits the reaction of polymerization to proceed more uniformly, and allows further polymerization. This invention has been perfected as a result.

By this invention, the water-soluble porous polymer can be produced easily and conveniently.

This invention is particularly characterized by causing the aqueous monomer solution containing an ethylenically unsaturated monomer to be polymerized while containing bubbles therein. When the porous polymer after completion of the polymerization acquires a volume 1.1-20 times the volume of the aqueous monomer solution prior to the polymerization, the produced water-soluble porous polymer has a small residual monomer content and a large molecular weight.

The water-soluble porous polymer of this invention really abounds in water solubility as evinced by such a small water-insoluble content as not more than 10 wt. % and, owing to its fabrication in a porous texture, excels in an aqueous solution-forming property.

### BEST MODE FOR EMBODYING THE INVENTION

The first aspect of this invention is directed toward a method for the production of a water-soluble porous polymer comprising a step of polymerization of an aqueous monomer solution while having bubbles contained in the monomer solution, thereby obtaining the porous polymer having a water-insoluble content of not more than 10 wt. %. A technique for producing a porous polymer with the object of enhancing an absorbent property already exists. It was obtained by polymerizing a monomer component containing an inner cross-linking agent, which polymer was a hydrophilic but not dissolved in water. Since the water-soluble polymer requires a long time for polymerization of an aqueous monomer solution, it is difficult to remain bubbles through the polymerization. Thus, absolutely no development has been made of a water-soluble porous polymer. This invention, however, has succeeded in developing a water-soluble porous polymer by curtailing the polymerization time of the aqueous monomer solution by including a photopolymerization initiator in the solution and the exposure of the solution to an ultraviolet light or a near ultraviolet light, or by enabling the foaming to continue for a long time owing to the adjustment of the viscosity of the aqueous monomer solution. Now, this invention will be described in detail below.

(1) Preparation of Aqueous Monomer Solution

The water-soluble porous polymer of this invention can be produced by polymerizing a relevant monomer in a medium. The monomers include ethylenically unsaturated monomers, carbonyl compounds, alcohols, and carboxylic acids, for example.

As concrete examples of the ethylenically unsaturated monomer, anionic monomers such as (meth)acrylic acid, maleic acid, maleic anhydride, fumaric acid, crotonic acid, itaconic acid, 2-(meth)acryloyl ethane sulfonic acid, 2-(meth)acryloyl propane sulfonic acid, 2-(meth)acrylamide-2-methyl propane sulfonic acid, vinyl sulfonic acid, and styrene sulfonic acid and lithium, sodium, potassium, and other alkali metal salts thereof and ammonium salts thereof; nonionic hydrophilic group-containing monomers such as (meth)acrylamide, N-substituted (meth)acrylamide, 2-hydroxyethyl(meth)acrylate, 2-hydroxypropyl(meth)acrylate, methoxypolyethylene glycol(meth)acrylate, polyethylene glycol(meth)acrylate, and N-vinyl acetamide; and amino group-containing unsaturated monomers such as N,N-dimethylaminoethyl(meth)acrylate, N,N-dimethylaminopropyl(meth)acrylate, and N,N-methylaminopropyl(meth)acrylamide and the products of quaternization thereof may be cited. Incidentally, N-vinyl pyrrolidone may be used specifically for copolymerization. It is permissible to use additionally such acrylic esters as methyl (meth)acrylate, ethyl (meth)acrylate, and butyl (meth)acrylate and hydrophobic monomers such as vinyl acetate and vinyl propionate in an amount incapable of impairing the water-soluility of the produced polymer.

As concrete examples of the carbonyl compound, aldehydes and ketones, cyclic ethers and lactones may be cited. As concrete examples of the alcohols, aliphatic alcohols, aromatic alcohols, and diols may be cited. As concrete examples of the carboxylic acids, aliphatic carboxylic acids, aromatic carboxylic acids, amines, and thiols may be cited. These monomers may be used either singly or in the form of a combination of two or more members.

In this invention, it is preferable to use ethylenically unsaturated monomers among them. It is particularly preferable to use at least one member selected from the group consisting of (meth)acrylic acid and salts thereof, 2-(meth)acryloyl ethane sulfonic acid and salts thereof, 2-(meth)acrylamide-2-methyl propane sulfonic acid and salts thereof, (meth)acrylamide, methoxypolyethylene glycol(meth)acrylate, N,N-dimethylaminoethyl(meth)acrylate and the products of quaternization thereof. It is still more preferable to use a monomer component which contains (meth)acrylic acid or a salt thereof as an essential component. When the monomer component forms a “salt” such as an acrylate, it is permissible to prepare an aqueous solution containing an acid type acrylic acid as a monomer component and subsequently transform the monomer component by addition of an alkali into a neutral salt. Otherwise, it is permissible to use a neutral salt type acrylic acid as a monomer component. As concrete examples of the “salt, ” the salts of alkali metals and alkaline earth metals may be cited.

The viscosity of the aqueous monomer solution does not need to be particularly restricted. The adjustment of this viscosity in the range of 0.001 to 1.2 Pa·s, preferably 0.001 to 1.0 Pa·S, and still more preferably 0.001 to 0.6 Pa·s, however, enables the bubbles to be stably dispersed in the aqueous monomer solution. If the viscosity exceeds 1.2 Pa·s, the excess will possibly render difficult uniform dispersion in the aqueous monomer solution of a foaming agent which is usable in this invention. Further, the aqueous monomer solution may be not easy to transfer with a pump by the excess viscosity.

The concentration of the aqueous monomer solution is not particularly restricted. When it is adjusted to a level of not less than 40 wt. %, it can be simplify the drying and pulverization steps of the obtained polymer. It is preferably not less than 50 wt. %, still more preferably not less than 60 wt. %, and the most preferably not less than 70 wt. %. If the concentration of the aqueous monomer solution is lower than 40 wt. %, the shortage will be at a disadvantage in increasing the water content of the solution, requiring the drying to be carried out at a higher temperature for a longer time, necessitating an increase in the size of the device, and impairing the efficiency of production. The increase of the concentration of the aqueous monomer solution brings a proportionate decrease in the water content of the produced polymer and consequently enhances the efficiency of the treatments of drying and pulverization proportionately. It occurs at times that the higher concentration possibly allows omission of the step of drying. When the aqueous monomer solution is polymerized at a high concentration, the product of the polymerization can be immediately pulverized and obtained the powder aimed at easily. The increase of the concentration of the aqueous monomer solution results in heightening the viscosity of itself and consequently adding to the power of holding bubbles and ensuring production of a water-soluble porous polymer of high quality.

For the sake of heightening the viscosity of the aqueous monomer solution, the solution may incorporate a thickening agent therein. The thickening agent is required to be a water-soluble polymer. For example, oligoacrylic acid (salt), polyacrylic acid (salt), polyvinyl alcohol, polyvinyl pyrrolidone, polyacrylamide, polyethylene oxide, hydroxyethyl cellulose, carboxymethyl cellulose, and hydroxy propyl cellulose are usable. These water-soluble polymers usable as a thickening agent have a weight average molecular weight in the range of 1,000-10,000,000 and preferably 10,000-5,000,000. If the average molecular weight falls short of 1,000, the shortage will be at a disadvantage in increasing the amount of the thickening agent to be added and possibly degrading the water solubility. The amount of the thickening agent to be added does not need to be particularly restricted but is only required to allow the viscosity of the aqueous monomer solution to reach a level of not more than 1.2 Pa·s. Generally, this amount is in the range of 0.01-3 wt. %, preferably 0.1-1 wt. % based on the weight of the monomer. If the amount of the thickening agent to be added falls short of 0.01 wt. %, the shortage will possibly prevent the effect of enhancing the viscosity from being satisfactorily manifested.

For the sake of adjusting the viscosity in the range specified above, when the monomer component is an ethylenically unsaturated monomer, for example, the amount of the neutral salt type monomer to be incorporated may be controlled in the range of 5-100 mol %, preferably 10-100 mol %. The ethylenically unsaturated monomer may possibly have the viscosity thereof in the aqueous solution vary between the acid type and the neutralized salt type of itself. Generally, the neutralized salt type has a higher viscosity. Thus, the viscosity can be controlled by adjusting the amount of the neutralized salt type to be incorporated. Since it is made possible to adjust the viscosity and allow the bubbles to be retained advantageously during the course of the polymerization by controlling the amount of the neutralized salt type monomer, the obtained polymer may be reverted to the acid type by treatment with an acid or adjusted to the wholly neutralized salt type by treatment with an alkali. Furthermore, by adjusting the amount of the alkali to be used in the treatment, it is made possible to obtain a water-soluble porous polymer containing a neutralized salt as expected. This procedure is at an advantage in allowing the viscosity to be adjusted without requiring incorporation of such additives as a thickening agent, for example.

The production of a hydrophilic polymer possessing a cross-linked structure has been attained hitherto by positively supplying the scene of polymerization with bubbles. In the case of the water-soluble polymer having a small water-insoluble content contemplated by this invention, the production of a water-soluble porous polymer by the procedure of positively supplying bubbles has not been realized. It seems that in the case of a hydrophilic polymer possessing a cross-linked structure, the reaction solution has a very high viscosity and is enabled to retain bubbles easily therein. The water-soluble polymer of this invention having a small water-insoluble content is a hydrophilic polymer possessing no cross-linked structure. Owing to the absence of the cross-linked structure, the reaction solution has a low viscosity and is not enabled to retain bubbles till completion of the polymerization. Now, this invention has realized the synthesis of a water-soluble porous polymer by exalting the power of the reaction solution to retain bubbles therein by adjusting the viscosity of the reaction solution in accordance with the method described above and adopting as well a varying foaming means described herein below.

When the aqueous monomer solution mentioned above is polymerized, it is preferable to have a radical polymerization initiator dissolved or dispersed in advance in the aqueous polymer solution. Such radical polymerization initiators include azo compounds such as azonitrile compounds, azoamidine compounds, cyclic azoamidine compounds, azoamide compounds, alkyl azo compounds, 2,2′-azobis(2-amidinopropane)dihydrochloride, and 2,2′-azobis[2-(2-imidazolin-2-yl)propane]dihydrochloride); persulfates such as ammonium persulfate, potassium persulfate, and sodium persulfate; peroxides such as hydrogen peroxide, methylethyl ketone peroxide, benzoyl peroxide, cumene hydroperoxide, and di-t-butyl peroxide; and redox initiators formed by combining the peroxides mentioned above with such reducing agents as sulphites, bisulfites, thiosulfates, formamidine sulfinic acid, and ascorbic acid, for example. These radical polymerization initiators may be used either singly or in the form of a combination of two or more members. The radical polymerization initiator usable advantageously in this invention is incorporated in an amount falling preferably in the range of 0.0001-10 wt. parts, more preferably 0.0005-5 wt. parts, and particularly preferably 0.001-1 wt. part, based on 100 wt. parts of the ethylenically unsaturated monomer.

Further, this invention allows use of such photopolymerization initiators as benzoin derivatives, benzyl derivatives, acetophenone derivatives, benzophenone derivatives, and azo compounds for the purpose of initiating polymerization as a polymerization initiator. Use of a photopolymerization initiator and ultraviolet light and/or near ultraviolet light proves a preferable method.

As concrete examples of the photopolymerization initiator usable herein, azo type photopolymerization initiators such as 2,2′-azobis(2-amidinopropane), 2,2′-azobis(N,N′-dimethylene isobutylamidine), 2,2-azobis[2-(5-methyl-2-imidazolin-2-yl)propane], 1,1′-azobis(1-amidino-1-cyclopropylethane), 2,2′-azobis(2-amidino-4-methylpentane), 2,2′-azobis(2-N-phenyl-aminoamidinopropane), 2,2′-azobis(1-imino-1-ethylamino-2-methylpropane), 2,2′-azobis(1-allylamino-1-imino-2-methylbutane), 2,2′-azobis(2-N-cyclohexylamidinopropane), 2,2′-azobis(2-N-benzylaminopropane), hydrochlorides, sulfates, and acetates thereof, 4,4′-azobis(4-cyanovaleric acid) and alkali metal salt, ammonium salt, and amine salt thereof, 2-(carbamoylazo)isobutylonitrile, 2,2′-azobis(isobutylamide), 2,2′-azobis[2-methyl-N-(2-hydroxyethyl)propionamide], 2,2′-azobis[2-methyl-N-(1,1′-bis(hydroxymethyl)ethyl)propionamide], and 2,2′-azobis[2-methyl-N-1,1′-bis(hydroxyethyl)propionamide];

benzoyl type photopolymerization initiators such as eutectic mixtures of 2,2-dimethoxy-1,2-diphenylethan-1-on, 1-hydroxy-cyclohexyl-phenyl-ketone, 2-hydroxy-2-methyl-1-phenyl-propan-1-on, and 1-hydroxy-cyclohexyl-phenyl-ketone (Irgacure 184) with benzophenone; 3:7 mixtures of 2-hydroxy-2-methyl-1-phenyl-propan-1-on (Darocur 1173), 1-[4-(2-hydroxyethoxy)-phenyl]-2-hydroxy-2-methyl-1-propan-1-on, 2-methyl-1-[4-(methylthio)phenyl)]-2-morpholinopropan-1-on, 2-benzyl-2-dimethylamino-1-(4-morpholinophenyl)-butanon-1, and 2-benzyl-2-dimethylamino-1-(4-morpholinophenyl)-butanon-1 (Irgacure 369) with 2,2-dimethoxy-1,2-diphenylethan-1-on (Irgacure 651); 1:3 mixtures of bis(2,4,6-trimethylbenzoyl)-phenylphosphinoxide (Irgacure 819), bis(2,4,6-trimethylbenzoyl)-phenylphosphinoxide, and bis(2,6-dimethoxybenzoyl)-2,4,4-trimethyl-pentylphosphin oxide (CG1403) with 2-hydroxy-2-methyl-1-phenyl-propan-1-on, 1:3 mixture of bis(2,6-dimethoxybenzoyl)-2,4,4-trimethyl-pentylphosphin oxide (CG1403) with 1-hydroxy-chlorohexyl-phenyl-ketone (Irgacure 184), a 1:1 mixture of bis(2,6-dimethoxybenzoyl-2,4,4-trimethyl-pentylphosphinoxide (CG14034) with 1-hydroxy-cyclohexyl-phenyl-ketone (Irgacure 184), a 1:1 liquid mixture of 2,4-6-trimethylbenzoyl-diphenyl-phosphinoxide with 2-hydroxy-2-methyl-1-phenyl-propan-1-on (Darocur 1173), and bis(η⁵-2,4-cyclopentadien-1-yl)bis(2,6-difluoro-3-(1H-pyrrol-1-yl)-phenyl)titanium,

eutectic mixtures of oligo[2-hydroxy-2-methyl-1-[4-(1-methylvinyl)phenyl]propanone and 2,4,6-trimethylbenzophenone with 4-methylbenzophenone, a liquid mixture of 4-methylbenzophenone with banzophenone, a liquid mixture of 2,4,6-trimethylbenzoyldiphenylphosphinoxide with oligo[2-hydroxy-2-methyl-1-[4-(1-methylvinyl)phenyl]propanone] and a methylbenzophenone derivative; 1-[4-(4-benzoylphenylsulfanyl)phenyl]-2-methyl-2-(4-methylphenylsulfanyl)propan-1-on, benzyldimethylketal, 2-hydroxy-2-methyl-1-phenyl-1-propanone, α-hydroxycyclohexyl-phenylketone, ethyl-4-dimethylaminobenzoate, acrylamine synergist, benzoin (iso- and n-)butylester, acryl sulfonium (mono, di)hexafluorophosphate, 2-isopropyl thioxanthone, 4-benzoyl-4′-methyldiphenylsulfide, 2-butoxyethyl-4-(dimethylamino)benzoate, and ethyl-4-(dimethylamino)benzoate, and

benzoin, benzoinalkylether, benzoinhydroxyalkylether, diacetyl and derivatives thereof, anthraquinone and derivatives thereof, diphenyl disulfide and derivatives thereof, benzophenone and derivatives thereof, and benzyl and derivatives thereof may be cited. These photopolymerization initiators may be used either singly or in the form of a combination of two or more members.

Among other photopolymerization initiators enumerated above, the benzoin type photopolymerization initiators such as, for example, 2-hydroxy-2-methyl-1-phenyl-propan-1-on and bis(2,4,6-trimethylbenzoyl)-phenylphosphinoxide are used particularly advantageously.

The amount of the photopolymerization initiator to be used is preferably in the range of 0.0001-10 wt. parts, more preferably 0.0005-5 wt. parts, and particularly preferably 0.001-1 wt. part, based on 100 wt. parts of the monomer. If the amount of the initiator falls short of 0.0001 wt. part, the shortage will result in greatly lowering the polymerization velocity. Conversely, if this amount exceeds 10 wt. parts, the overage will possibly result in emitting an unduly large heat and increasing the water-insoluble content.

This invention permits addition of a chain transfer agent to the reaction system. The chain transfer agents which are usable herein include sulfur-containing compounds, phosphorous acid type compounds, hypophosphorous acid type compounds, and alcohols, for example. By adding such a chain transfer agent, it is made possible to adjust the cross-linking reaction, keeping the water-insoluble content to less than 10 wt. %, and repressing the occurrence of a short-chain polymer.

As concrete examples of the sulfur-containing compound, hypophosphorous acids (salts) such as sodium hydrogen sulfite, potassium hydrogen sulfite, and ammonium hydrogen sulfite, thiols such as mercapto ethanol, thioglycerol, thioglycolic acid, thioacetic acid, mercapto ethanol, 2-mercapto propionic acid, 3-mercapto propionic acid, thiomalic acid, octyl thioglycolate, octyl 3-mercapto propionate, and 2-mercapto ethane sulfonic acid, and thiolic acids may be cited. As concrete examples of the phosphorous acid type compound, phosporous acid and sodium phosphite may be cited. As concrete examples of the hypophosphorous acid type compound, hypophosphorous acid and sodium hypophosphite may be cited. As concrete examples of the alcohol, methyl alcohol, ethyl alcohol, isopropyl alcohol, and n-butyl alcohol may be cited. These compounds may be used either singly or in the form of a combination of two or more members. Among other compounds enumerated above, hydophosphorous acid type compounds prove advantageous and sodium hypophosphite proves more advantageous.

The amount of the chain transfer agent to be incorporated may be properly set so as to suit the polymerization velocity and the combination of this agent with a photopolymerization initiator. It is preferably in the range of 0.0001-10 wt. parts and more preferably 0.005-5 wt. parts, based on 100 wt. parts of the monomer.

As regards the relation between the polymerization initiator and the chain transfer agent, the ratio of their combination (polymerization initiator/chain transfer agent), in terms of the weight per 1 mol of the monomer, is not more than 10, preferably not more than 5, and the most preferably not more than 3. If this ratio of combination exceeds 10, the overage will be at a disadvantage in suffering the water-insoluble content of the resultant porous product and the powder to exceed 10 wt. %.

Further, the aqueous monomer solution may incorporate therein a surfactant with the object of facilitating the generation and retention of bubbles in the solution. The surfactants which are usable herein include anionic surfactants, nonionic surfactants, cationic surfactants, amphoteric surfactants, fluorine type surfactants, and organic metal surfactants, for example.

As concrete examples of the anionic surfactant, aliphatic acid salts such as mixed fatty acid sodium soap, semi-hard tallow fatty acid sodium soap, sodium stearate soap, potassium oleate soap, and castor oil potassium soap; alkyl sulfuric ester salts such as sodium lauryl sulfate, higher alcohol sodium sulfate, lauryl sodium sulfate, and lauryl sulfuric acid triethanol amine; alkylbenzene sulfonates such as sodium dodecylbenzene sulfonate; alkyl naphthalene sulfonates such as sodium alkylnaphthalene sulfonate; alkyl sulfosuccinates such as sodium dialkyl sulfosuccinate; alkyl diphenyl ether disulfonates such as sodium alkyldiphenyl ether disulfonate; alkyl phosphorates such as potassium alkyl phosphate; polyoxyethylene alkyl (or alkylallyl) sulfuric acid ester salts such as polyoxyethylene lauryl ether sodium sulfate, polyoxyethylene alkyl ether sodium sulfate, polyoxyethylene alkyl ether sulfuric acid triethanol amine, and polyoxyethylenealkylphenyl ether sodium sulfate; special reaction type anionic surfactants; special caraboxylic acid type surfactants; naphthalene sulfonic acid formalin condensates such as sodium salts of β-naphthalene sulfonic acid formalin condensate and sodium salts of special aromatic sulfonic acid formalin condensate; special polycarbonic acid type macomolecular surfactants; and polyoxyethylene alkylphospholic acid esters may be cited.

As concrete examples of the nonionic surfactant, sucrose fatty acid esters; polyoxyethylene alkyl ethers such as polyoxyethylene lauryl ether, polyoxyethylene cetyl ether, polyoxyethylene stearyl ether, polyoxyethylene oleyl ether and, polyoxyethylene higher alcohol ethers, polyoxyethylene alkylaryl ethers such as polyoxyethylene nonylphenyl ether; polyoxyethylene derivatives; sorbitan fatty acid esters such as sorbitan monolaurate, sorbitan monopalmitate, sorbitan monostearate, sorbitan tristearate, sorbitan monooleate, sorbitan trioleate, sorbitan sesquioleate, and sorbitan distearate; polyoxyethylene sorbitan fatty acid esters such as polyoxyethylene sorbitan monolaurate, polyoxyethylene sorbitan monopalminate, polyoxyethylene sorbitan monostearate, polyoxyethylene sorbitan tristearate, polyoxyethylene sorbitan monooleate, and polyoxyethylene sorbitan trioleate; polyoxyethylene sorbitol fatty acid esters such as tetraoleic acid polyoxyethylene sorbit; glycerin fatty acid esters such as glycerol monostearate, glycerol monooleate, and self-emulsifying glycerol monostearate; polyoxyethylene fatty acid esters such as polyethylene glycol monolaurate, polyethylene glycol monostearate, polyethylene glycol distearate, and polyethylene glycolmonooleate; polyoxyethylene alkyl amine; polyoxyethylene hardened castor oil; and alkyl alkanol amides may be cited.

As concrete examples of the cationic surfactant and the amphoteric surfactant, alkyl amine salts such as coconut amine acetate and stearyl amine acetate; quaternary ammonium salts such as lauryl trimethyl ammonium chloride, stearyl trimethyl ammmonium chloride, cetyl trimethyl ammonium chloride, distearyl dimethyl ammonium chloride, and alkylbenzyl dimethyl ammonium chloride; alkyl betaines such as lauryl betaine, stearyl betaine, and lauryl carboxymethyl hydroxyethyl imidazolinium betaine; and amine oxides such as lauryl dimethyl amine oxide may be cited. By using a cationic surfactant, it may be made possible to impart an antifungal property to the water-soluble polymer to be produced.

The surfactants usable herein further include fluorine type surfactants. By using a fluorine type surfactant, it is made possible to have bubbles of an inert gas retained as stably dispersed in the aqueous monomer solution for a long time. The amount and the diameter of such bubbles are also controlled easily. The water-soluble polymer is consequently obtained in the form of a porous foamed mass. It can be endowed with an antibacterial property. The fluorine type surfactants which are usable in this invention are known in various kinds. They result from transforming the lipophilic group of an ordinary surfactant into a perfluoroalkyl group by the substitution of the hydrogen atom in the oleophilic group with a fluorine atom. They acquire a decisively intensified surface activity owing to the transformation.

The hydrophilic group of the fluorine type surfactant can be varied into four kinds, i.e. anionic type, nonionic type, cationic type, and amphoteric type. The hydrophobic group thereof makes use of the fluorocarbon chain of the same configuration more often than not. The carbon chain which is the hydrophobic group may be used alike in the straight chain form or the branched form. Typical fluorine type surfactants are those which are enumerated below.

Fluoroalkyl(C₂-C₁₀)carboxylic acids, N-perfluorooctane sulfonyl glutamic acid disodium, 3-[fluoroalkyl(C₆-C₁₁)oxy]-1-alkyl(C₃-C₄)sulfonic acid sodium, 3-[ω-fluoroalkanoyl(C₆-C₈)—N-ethylamino]-1-propane sulfonic acid sodium, N-[3-(perflfuorooctane sulfonamide)propyl]-N,N-dimethyl-N-carboxymethylene ammonium betaine, fluoroalkyl (C₁₁-C₂₀) carboxylic acid, perfluoroalkyl carboxylic acid (C₇-C₁₃), perfluorooctane sulfonic acid diethanol amide, perfluoroalkyl (C₄-C₁₂) sulfonic acid salt (Li, K, Na), N-propyl-N-(2-hydroxyethyl)perfluorooctane sulfonamide, perfluoroalkyl (C₆-C₁₀) sulfonamide propyl trimethyl ammonium salt, perfluoroalkyl (C₆-C₁₀)—N-ethylsulfonyl glycin salt (K), phosphoric acid bis(N-perfluorooctyl sulfonyl-N-ethylaminoethyl), monoperfluoroalkyl (C₆-C₁₆) ethylphosphoric acid ester, perfluoroalkyl quaternary ammonium iodide (a cationic fluorine type surfactant made by Sumitomo 3M K.K. and sold under the trademark designation of “Florard FC-135”), perfluoroalkyl alkoxylate (a nonionic surfactant made by Sumitomo 3M K.K. and sold under the trademark designation of “Florard FC-171”), and perfluoroalkylsulfonic acid potassium salt (an anionic surfactant made by Sumitomo 3M K.K. and sold under the trademark designation of “Florard FC-95 and FC-98”).

The organic metal surfactants are also usable herein. The term “organic metal surfactant” refers to a molecule having such metals as Si, Ti, Sn, Zr, and Ge in the main chain or the side chain thereof. Among other conceivable organic metal surfactants, those which have Si in the main chain of the molecule prove particularly advantageous. Siloxane type surfactants prove more advantageous.

As typical organic metal surfactants, those represented by the following formulas (1)-(19) may be cited (Yoshida, Kondo, Ohgaki, and Yamanaka, “Surfactant Handbook, new edition,” Kogaku Tosho (1966), p. 34).
(C₂H₅)₃Si(CH₂)ₙCOOHn=6˜10 (1)
C₆H₅(CH₃)₂Si(CH₂)₂COOH (2)
HOOCC₂H₄Si(CH₃)₂O(CH₃)₂SiC₂H₄COOH (3)
(CH₃)₃SiOSi(CH₂)₂SCH₂COOH (4)
[(CH₃)₃SiO]₂Si(CH₃)(CH₂)₃OSO₃H (amine salt) (5)
(C₄H₉O)₂Si(OC₂H₄NH₂)₂.2R¹COOH (6)
[(CH₃)₃SiO]₃Si(CH₂)₃NH(CH₂)₂NH₂ (7)
[(R¹NR²R³)₄₋ₐSi(R⁴)ₐ]^{(4-a)⊕}.(4·a)Cl^{⊖} (8)

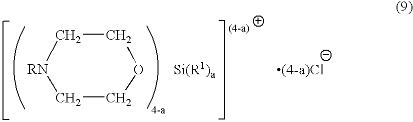

HO(C₂H₄C)₃SiC₂H₄COO(C₂H₄O)₃H (10)
(CH₃)₃SiC₆H₄OC₂H₄OH (11)
C₁₈H₃₇Si[O(C₂H₄O)ₙH]S (12)
(BuO)₃Ti[OTi(OBu)(OCOC₁₇H₃₅)]ₙOTi(OBu)₂ (13)

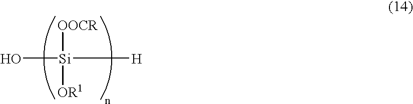

Si[OCH₂CH₂)ₙOR]₄ (15)
RO(CH₂CH₂O)ₙ]₂Ti(OC₄H₉)₂ (16)
[RO(CH₂CH₂O)ₙ]₂TiOOTi[(C₂H₄O)ₙOR]₂ (17)

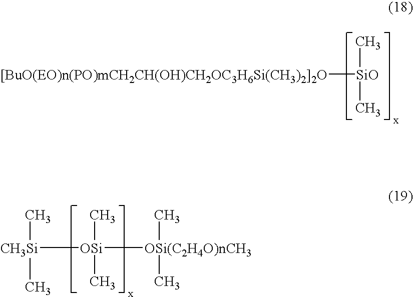

As the metals to be contained in the organic metal surfactants represented by the foregoing formulas (1)-(19), Sn, Zr, Ge, etc. may be used in the place of Si or Ti.

The surfactants mentioned above are incapable of emitting bubbles in themselves or enabling the aqueous monomer solution to contain bubbles. When they are added to the aqueous monomer solution, they enable the aqueous solution to retain the bubbles to be generated by a stirring and mixing operation or by the use of a foaming agent.

Kinds of surfactants to be used may be selected based on factors of the aqueous monomer solution such as pH, for example, and their amounts to be incorporated are also decided in accordance with the due data offered above with respect to the foregoing surfactants. Incidentally, these surfactants may be utilized as an agent for regulating the foaming, depending on the condition of use.

They may be used either singly or in the form of a combination of two or more members. This invention prefers use of sucrose fatty acid esters and sorbitan type surfactants, especially sorbitan monostearate, particularly among other surfactants enumerated above.

These surfactants are used in an amount in the range of 0.001-100 wt. parts, preferably 0.005-80 wt. parts, and particularly preferably 0.01-30 wt. parts, based on 100 wt. parts of the monomer to be used. If this amount falls short of 0.001 wt. part, the shortage will possibly render difficult the adjustment of the volume of the porous polymer after completion of polymerization to 1.1-20 times the volume of the aqueous monomer solution existing at the time of starting polymerization. Conversely, if the amount exceeds 100 wt. parts, the overage may possibly fail to bring a proportionate addition to the effect expected.

The aqueous monomer solution to be used in this invention allows additional incorporation therein of the aqueous solution of starch, a derivative of starch, a water-soluble polymer of cellulose, poly(sodium acrylate), and poly(ethylene oxide).

As the solvent to be used in the production of a water-soluble porous polymer, water proves a proper choice. It is nevertheless permissible to use an aqueous solution of such lower alcohol as methanol, ethanol, or propanol, an amide such as dimethyl formamide or dimethyl acetamide, or an ether such as diethyl ether, dioxane, or tetrahydrofuran.

(2) Preparation of Bubbles

This invention is characterized by polymerizing the aqueous monomer solution mentioned above while keeping the presence of bubbles in the solution. As a means to induce bubbles therein during the course of polymerization, (I) a method which polymerizes a product obtained by stirring and mixing an inert gas with the aqueous monomer solution in advance, (II) a method which comprises adding a foaming agent to the aqueous monomer solution and polymerizing the resultant mixture while foaming it by the heat of polymerization, and (III) a method of boiling point polymerization are available.

The method (I) of stirring and mixing the inert gas is known in such forms as (I-1) a method of extruding the aqueous monomer solution in the form of mousse and feeding it to the polymerization device, (I-2) a method of stirring and mixing the aqueous monomer solution in a mixing device adapted to allow incorporation of the inert gas into the solution under treatment therein, (I-3) a method of generating bubbles resembling soap bubbles by means of bubbling, and (I-4) a method of causing nitrogen gas or carbon dioxide to be dissolved in the aqueous monomer solution under pressure. As the inert gas to be incorporated in the aqueous monomer solution, nitrogen, carbon dioxide, argon, and helium are available.

(I-1):

For the sake of preparing the aqueous monomer solution in the form of mousse, the aqueous monomer solution is extruded in the form of mousse through a pump type nozzle, for example. When the aqueous monomer solution has a surfactant incorporated therein at this time, the surfactant is effective in retaining the bubbles during the course of polymerization. By selecting the kind of surfactant and properly controlling the amount thereof, it is made possible to regulate the pore diameter and the water-solubility of the produced water-soluble porous polymer.

(I-2):

For the sake of stirring and mixing the aqueous monomer solution in a mixing device thereby inducing bubbles in the solution, a method which comprises preparing an aqueous monomer solution incorporating therein the surfactant and causing the aqueous solution to foam by the use of a static mixer is available. The static mixer has lateral elements alternately disposed inside a pipe. On admitting the streams of the aqueous monomer solution and the inert gas therein, this static mixer mixes them and gives rise to the aqueous monomer solution containing the gas.

As a means to induce bubbles by stirring and mixing, a method which, as disclosed in JP-A-1998-251310, comprises mixing the aqueous monomer solution and the inert gas by advancing them in parallel flow and causing either of the two parallel streams to be projected via a nozzle into the other stream may be adopted. By mixing the aqueous monomer solution and the inert gas both in the form of fluid, it is made possible to have the inert gas to be dispersed uniformly and stably in the aqueous monomer solution. Then, by polymerizing the aqueous monomer solution in a state having the inert gas disposed in advance therein, it is made possible to facilitate the control of the pore diameter and produce a porous polymer abounding in water solubility. To be specific, a method which effects mixture of the streams of the aqueous monomer solution and the inert gas by causing either of the two streams to be injected via a nozzle into the other stream is available. The mixture is accomplished, for example, by causing the inert gas injected through one nozzle to flow parallelly to the stream of the aqueous monomer solution injected through another nozzle or by causing the aqueous monomer solution injected through one nozzle to flow parallelly to the stream of the inert gas injected through another nozzle. It is permissible to have the inert gas directly blown into the stream of the aqueous monomer solution. For the sake of stirring and mixing the two streams, they may be projected in a parallel flow or a counterflow or in a perpendicular flow. The mode of projecting them in a parallel flow is preferred over the other modes. The projection in the parallel flow allows the bubbles to be uniformly dispersed. The projection in the counter flow possibly results in causing the two streams to scatter, adhere to the inner wall of the mixing device, and yield per se to polymerization.

As the device for stirring and mixing the two streams, an aspirator and an ejector may be used. Subsequently, by introducing the mixture of the aqueous monomer solution and the inert gas into a mixing zone which is furnished with a corrugation and/or a packing adapted to obstruct the flow of a fluid, it is made possible to effect uniform mixture of the two components in the mixture. As concrete examples of the corrugation or the packing serving to obstruct the flow of a fluid, mixing zones provided with projections, vanes, baffle plates, and packing materials may be cited. The mixing device of this construction may be operated by following the procedure which is disclosed in JP-A-1998-251310.

For the sake of enabling the porous polymer resulting from the polymerization to assume a volume 1.1-20 times the volume of the aqueous monomer solution prior to the polymerization, the amount of the gas to be mixed is adjusted.

(I-3):

The expression “the method of generating bubbles resembling soap bubbles by means of bubbling” used herein refers to a method which comprise adding the aqueous monomer solution and the aforementioned surfactant together in advance and causing the foam generated by the introduction of an inert gas such as nitrogen gas, carbon dioxide, or argon gas to be introduced as occasion demands into the polymerization phase.

(I-4)

The expression “the method of dissolving nitrogen gas and carbon dioxide under pressure” refers to a method which comprises mixing the inert gas into the aqueous monomer solution in advance and then polymerizing the aqueous monomer solution while enabling the gas to be radiated by the heat of polymerization during the polymerization and enabling the aqueous monomer solution to contain the bubbles.

The method comprises placing the aqueous monomer solution in a pressure vessel such as an autoclave, introducing an inert gas such as nitrogen gas or carbon dioxide therein, retaining the interior of the vessel under pressure of not more than 5 MPa, and causing the inert gas to be dissolved in the aqueous monomer solution thereby inducing bubbles therein. This method exalts the content of bubbles in the aqueous monomer solution because the amount of the inert gas to be dissolved into the aqueous monomer solution is larger under pressure than under normal pressure. This method brings an effect of enabling the aqueous monomer solution to be efficiently transferred into the polymerization phase by relieving the vessel of the pressure. If the pressure in the vessel exceeds 5 MPa at this time, the overage will be at a disadvantage in endangering the operation.

(II):

The expression “the method of incorporating a foaming agent” refers to a method which comprises having the foaming agent mixed and dispersed or dissolved in advance in the aqueous monomer solution and enabling the foaming agent to generate bubbles by the heat of polymerization. As the foaming technique, the use of a chemical foaming agent or a physical forming agent has been known. Generally, the chemical foaming agent and the physical foaming agent are each divided broadly under an organic type and an inorganic type. The chemical foaming agent can be further divided broadly under a thermal decomposition type and a reaction type. The chemical foaming agents of the organic thermal decomposition type include azo compounds such as azodicarbon amide and AIBN, hydrazido compounds, semicarbazido compounds, hydrazo compounds, tetrazole compounds, triazine compounds, and ester compounds such as malonate, for example. The chemical foaming agents of the organic reaction type include isocyanate compounds, for example.

Then, the chemical foaming agents of the inorganic thermal decomposition type include carbonates such as bicarbonates, sodium carbonate, potassium carbonate, ammonium carbonate, magnesium carbonate, calcium carbonate, sodium hydrogen carbonate, potassium hydrogen carbonate, ammonium hydrogen carbonate, magnesium hydrogen carbonate, calcium hydrogen carbonate, zinc carbonate, and barium carbonate, nitrites, and hydrides, for example. The chemical foaming agents of the inorganic reaction type include combinations of bicarbonates and acids, combinations of hydrogen peroxide and yeast, and combinations of aluminum and acids or alkalis, for example. The physical foaming agents of the organic type include aliphatic hydrocarbons formed of such volatile liquids as butane and pentane, and halogenated hydrocarbons such as dichloromethane, trichloroethane, and trifluforoethane, for example. The physical foaming agents of the inorganic type include nitrogen gas and carbonic acid gas, for example.

When the generation of bubbles is implemented by combining sodium carbonate or ammonium carbonate with an acid, the generation of bubbles occurs copiously immediately after mixture and it ceases to continue with the advance of the neutralization reaction. When the combination mentioned above is adopted, the polymerization is preferably initiated as soon as possible after the mixture of the chemical foaming agent of the inorganic type and the acid, specifically within two hours, preferably within one hour after the mixture.

It is also permissible to use foaming particulates which are formed of a core part of a low boiling organic solvent and a shell part of a nitrile type copolymer such as, for example, nitrile type thermally expanding microcapsules (sold under the product name of “Matsumoto Microsphere F-36”) and nitrile type thermally expanding microcapsules (sold under the product name of “Matsumoto Microsphere F-20”).

In this invention, these foaming agents may be used either singly or in the form of a combination of two or more members. The foaming agents which are advantageously usable in this invention are low boiling organic solvents such as pentane, butane, and fleon, thermally expanding microcapsules enclosing such volatile liquids therewith, inorganic foaming agents such as sodium bicarbonate and ammonium carbonate, and organic foaming agents such as a zodicarboxylic acid amide and AIBN among other foaming agents enumerated above. Besides, the foaming agents which are disclosed in JP-A-1999-35691, JP-A-1999-292919, JP-A-1999-302391, and JP-A-2000-63527 are advantageously usable.

When the foaming agent is incorporated in the aqueous monomer solution, the amount thereof to be used is in the range of 0.001-100 wt. parts, more preferably 0.005-80 wt. parts, and particularly preferably 0.01-30 wt. parts based on 100 wt. parts of the monomer. Such characteristic elements of the voids in the produced foamed article such as continuity, dependence, size, shape, distribution, and uniformity of size can be controlled by properly setting the foaming conditions to suit the purpose of foaming.

More specifically, a method which comprises preparing an aqueous monomer solution, adding this solution and a carbonate type foaming agent together thereby forming a carbonate-containing monomer solution, polymerizing this solution thereby obtaining a water-soluble porous polymer, or polymerizing an aqueous monomer solution having a low boiling organic solvent such as hexane dispersed therein thereby producing a microporous water-soluble porous polymer, or having a water-insoluble foaming agent dispersed in an aqueous monomer solution through the medium of a surfactant and subsequently polymerizing the solution while causing the foaming agent to emit bubbles in the solution is also available. It is also permissible to adopt a method which effects polymerization by the use of an azo initiator having a 10-hour half life at a temperature in the range of 30-120° C. (refer to WO 95/17455) and a method which consists in polymerizing a water-soluble monomer in the presence of a foaming agent formed of an acrylic acid salt complex of azo compound (refer to WO 96/17884).

In the conventional polymerization using a foaming agent, the reaction solution has been required to possess such viscosity as to retain bubbles therein. When a cross-linked structure is contained, the solution possesses sufficient viscosity and can produce a porous polymer. When no cross-linked structure is contained, however, the solution fails to retain bubbles therein and can not produce porous polymer. The water-soluble polymer produced by this invention has a high polymerization velocity and has an ability to adjust the polymerization temperature at a low level. Thus, it excels in the ability to retain bubbles from start of the polymerization to completion of it, therefore, allows production of a water-soluble porous polymer of high quality. Particularly, the addition of a surfactant results in the retention of bubbles in original diameters.

(III):

The term “the method of boiling point polymerization” refers to a method of repressing radiation of heat and heightening the polymerization velocity by causing the polymerization to start at a temperature approximating the boiling point of the aqueous monomer solution. The fact that the polymerization temperature can be retained in the neighborhood of the boiling point brings the advantage of nearly fixing the amount of heat during the course of polymerization and repressing the cross-linking reaction. At this time, the boiling may be utilized in generating bubbles. That is, this method consists in enabling the polymer to contain bubbles therein by completing the polymerization before the bubbles vanish.

The interval between the preparation of the bubbles mentioned above and the start of polymerization to be described below is preferably within two hours, more preferably within 1 hour, furthermore preferably within 30 minutes, and the most preferably within 10 minutes. When the bubbles are prepared by stirring and mixing an inert gas and they are then left standing for a period exceeding two hours, they will possibly vanish. Also when such a basic foaming agent as a carbonate is used where the monomer happens to be acrylic acid, the generation of a gas will possibly decrease with the elapse of time.

(3) Polymerization

The method for polymerizing the monomer does not need to be particularly restricted but is only required to enable an aqueous monomer solution having a polymerization initiator incorporated in advance therein to be polymerized while continuing to contain bubbles therein. Generally, the polymerization is effected thermally with the object of promoting the polymerization. For this thermal polymerization, any of the known methods such as aqueous solution polymerization, reversed-phase suspension polymerization, bulk polymerization, and precipitation polymerization may be adopted. The reaction conditions such as reaction temperature and reaction time do not need to be particularly restricted but may be properly selected to suit the composition of the monomer component to be used, the method of generating bubbles, and the kind and amount of a foaming agent.

Instead of the thermal polymerization, this invention may resort to the photopolymerization which is effected by having an aqueous monomer solution incorporate therein a photopolymerization initiator in advance and exposing the aqueous monomer solution to a radiation such as gamma ray, X ray, or electron ray or an ultraviolet light, near ultraviolet light, or visible light. It is also permissible to use the thermal polymerization and the photo polymerization together, namely to carry out the thermal polymerization while the photopolymerization is being performed by virtue of the exposure to the radiation such as gamma ray, X ray, or electron ray or ultraviolet light, near ultraviolet light, or visible light. This invention prefers sole use of photopolymerization or combined use of thermal polymerization and photopolymerization. The photopolymerization enjoys a short polymerization time and a low polymerization temperature and, therefore, brings such advantages as manifesting an excellent ability to retain bubbles, forming a small residual monomer, and ensuring production of a water-soluble porous polymer of a large weight average molecular weight. The water-soluble porous polymer consequently obtained, when used as a sanitary material, inflicts no significant stimulus on the skin because of the small residual monomer content and, when used to form an aqueous solution, allows an increase in the intrinsic viscosity of the produced solution because of the high weight average molecular weight.

As concrete examples of the light exposure device, high-pressure mercury lamp, low-pressure mercury lamp, metal halide lamp, fluorescent chemical lamp, fluorescent blue color lamp, blacklight mercury lamp, and xenon lamp may be cited. The wavelength of the light is in the range of 100-800 nm, more preferably 100-500 nm and particularly preferably 200-500 nm. If the wavelength falls short of 100 nm, the shortage will possibly render difficult the control of polymerization because of its strong effect of promoting polymerization, giving rise to bumping at times, and increasing to the insoluble component. Conversely, if the wavelength exceeds 800 nm, the overage will result in requiring the polymerization time to be increased. This problem can be solved by weakening the intensity first and then enhancing the intensity subsequently.

The intensity of irradiation is not more than 100 W/m², preferably not more than 80 W/m², and more preferably not more than 50 W/m². Thus, it is made possible to promote the polymerization quickly and produce a water-soluble porous polymer having a small residual monomer content and a relatively large weight average molecular weight. The photopolymerization may be performed with the intensity of exposure kept constant. Preferably, the intensity is kept constant below 100 W/m² and increased in the intermediate stage rather than at the start of the polymerization.

In the photopolymerization of this kind, the aqueous monomer solution is supplied in a thickness of not more than 100 mm, preferably not more than 50 mm, more preferably not more than 30 mm, and the most preferably not more than 10 mm and the thickness of the solution is exposed to the light. When the polymerization is started, the heat of polymerization is emitted. The temperature during the polymerization varies with the method of generating bubbles. Generally, this temperature is controlled in the range of 20-200° C., preferably 50-180° C., and more preferably 60-150° C.

This invention prefers the volume of the porous polymer after completion of the polymerization to be 1.1-20 times, preferably 1.3-20 times, and particularly preferably 1.5-20 times, the volume of the aqueous monomer solution prior to the polymerization. In the conventional operation of polymerization reaction performed in a stirred state, the change of volume due to the addition of bubbles does not reach 1.01 times the original volume. The change of volume exceeding 1.1 times the original volume may well be regarded as resulting from intentionally incorporating bubbles. Incidentally, the change in volume of the aqueous monomer solution during the polymerization can be easily confirmed because it is manifested as a proportionate change in height of the water line. If the volume of the water-soluble porous polymer after completion of the polymerization falls short of 1.1 times the volume of the aqueous monomer solution at the time of starting the polymerization, the shortage will possibly result in degrading the efficiency with which the molecular weight is increased and the cost of production is lowered by bubbling. If the volume exceeds 20 times the original volume, the overage will possibly degrade the efficiency with which the drying and the disintegrating are effected proportionately to the bulkiness.

In the case of the thermal polymerization, the time of starting polymerization is when the heating is started. In the case of the photopolymerization, the time of starting polymerization is when the exposure to the light is started. The time of completing polymerization is when the reaction of polymerization is completed. In the case of the thermal polymerization, this is when the heating is discontinued. In the case of the photopolymerization, this is when the exposure to light is discontinued.

When the aqueous monomer solution is made to contain therein bubbles in the form of mousse by the method of (I-1) mentioned above, generally, the mousse is extruded in a thickness in the range of 1-30 mm and more preferably 1-20 mm and the mousse is exposed to a light of an intensity of 5-100 W/m² and a wavelength of 200-600 nm for a period in the range of 30 seconds-30 minutes, more preferably 1-20 minutes, and particularly preferably 1-15 minutes, though variable with the content of bubbles. If the thickness exceeds 30 mm, the overage will result in preventing the light from reaching the bottom part of the mousse and unduly adding to the polymerization time. If the intensity of the light exceeds 100 W/m² and if the light exposure time exceeds 30 minutes, the overage will possibly result in bringing the disadvantage of encouraging a cross-linking reaction. When the aqueous monomer solution supplied in the form of a mousse is polymerized by the exposure of light, the polymerization time can be shortened as compared with the thermal polymerization and the polymerization can be advanced smoothly in spite of a low polymerization temperature and, as a result, the retention of bubbles is attained favorably and the product is obtained in a high concentration.

When the aqueous solution polymerization is applied to the aqueous monomer solution enabled to contain bubbles by the method of (I-2) mentioned above, this aqueous solution is fed in a height in the range of 1-20 mm and more preferably 1-10 mm and the sheet of the solution is exposed to a light of an intensity of 5-100 W/m² and a wavelength of 200-600 nm for a period in the range of 2-30 minutes and more preferably 2-20 minutes. At this time, the polymerization temperature is preferably in the range of 20-150° C. and more preferably 30-120° C. If these conditions deviate from the relevant ranges specified above, the deviation will possibly result in rendering difficult the adjustment of the volume of the produced polymer to 1.1-20 times the original volume.

When the bubbles are generated in the form of soap bubbles by the method of (I-3) mentioned above, the mass of bubbles is extruded in a thickness in the range of 1-30 mm and more preferably 1-20 mm and the extruded sheet of bubbles is exposed to a light of an intensity of 5-100 W/m² and a wavelength of 200-600 nm for a period in the range of 2-30 minutes, more preferably 2-20 minutes, and particularly preferably 2-15 minutes. If the thickness of the bubbles exceeds 30 mm, the overage will result in preventing the light from reaching the bottom part and unduly adding to the polymerization time. If the intensity of the light exceeds 100 W/m² and if the exposure time exceeds 30 minutes, the overage will possibly result in inducing vanishment of bubbles.

When the aqueous monomer solution is caused to have air bubbled dissolved therein by the method of (I-4) mentioned above, this aqueous monomer solution is extruded in a height in the range of 1-20 mm and more preferably 1-10 mm and the extruded sheet is exposed to a light of an intensity of 5-100 W/m² and a wavelength of 200-600 nm for a period in the range of 2-30 minutes and more preferably 2-20 minutes. At this time, the polymerization is performed at a temperature preferably in the range of 20-150° C. and more preferably 30- 120° C. If these conditions deviate from the relevant ranges specified above, the deviation will possibly result in rendering difficult the adjustment of the volume of the resultant polymer to 1.1- 20 times the original volume.

When the aqueous monomer solution containing a photopolymerization initiator is caused to have a foaming agent dissolved or dispersed therein by the method of (II) mentioned above, this aqueous monomer solution is preferred to be subjected to photopolymerization under the same conditions as when the aqueous monomer solution is supplied in the form of mousse. The aqueous monomer solution prior to polymerization is supplied in a thickness in the range of 0.5-30 mm, more preferably 1-20 mm and particularly preferably 1-10 mm. As a result, the polymerization by the exposure to light can be initiated and advanced fully satisfactorily even when the volume thereof is increased by bubbling.

In the case of the boiling point polymerization of (III), it is preferred to be performed under the same conditions as in the case of (II) mentioned above.

For the polymerization reaction, either continuous polymerization or batch polymerization may be adopted. The polymerization may be carried out under a reduced pressure, an increased pressure, or normal pressure. Incidentally, the polymerization is preferred to be performed in a stream of such an inert gas as nitrogen, helium, argon, or carbonic acid gas. When the oxygen concentration in the aqueous monomer solution is satisfactorily decreased, the polymerization may be carried out in an atmosphere of air.

(4) Water-Soluble Porous Polymer

The shape of the water-soluble porous polymer obtained as described above varies with the method of polymerization used. The polymer may be in any of various shapes such as particles, a belt, a plate, or a clayish mass. The water-soluble porous polymer obtained by the method described above has a weight average molecular weight, determined by the GPC as reduced to polyacrylic acid, in the range of 1,000-10,000,000, preferably 5,000-10,000,000, and more preferably 5,000-8,000,000. Since the polymerization proceeds in the aqueous monomer solution containing bubbles, the polymerization is performed uniformly and the polymer consequently formed has a higher molecular weight then ever. This polymer has a water-insoluble content of not more than 10 wt. %, more preferably not more than 7 wt. % and the most preferably not more than 5 wt. %. Thus, the porous polymer truly excels in water-solubility as compared with the conventional porous polymer. It is provided that the “water-insoluble content” is determined by the method which is described in the working examples cited herein below.

The water-soluble porous polymer mentioned above has an air bubble content in the range of 2-90% and preferably 5-80%. Since this polymer has a voids ratio in the range mentioned above, it enjoys an enhanced water-solubility. The percentage of voids is determined by photographing the cross section of the porous polymer by the use of a scanning electron microscope (made by Hitachi, Ltd. and sold under the product code of “SEM: S-3500N type”) and analyzing the photograph with an image analyzing device (made by Nippon Shokubai K.K.) thereby calculating the total area of the bubbles in accordance with the following formula.
Percentage of voids (%)=100×(area of bubbles/total area analyzed)

The water-soluble porous polymer obtained by the method described above has viscosity preferably in the range of 0.001-10 Pa·s, more preferably 0.002-5 Pa·s, and particularly preferably0.003-2 Pa·s. When the viscosity is in the range specified above, the water-soluble porous polymer can manifest a truly excellent effect as a flocculant and a tackifier. The viscosity is the numerical value obtained by preparing an aqueous 0.2 wt. % solution of the powder and measuring the solution for viscosity by the use of a B type viscosimeter at 25° C. This invention can accomplish the polymerization in a short time at a low temperature owing to the photopolymerization and can effect the production of a water-soluble porous polymer of a high molecular weight in a short time owing to the incorporation of a chain transfer agent. While the viscosity of a water-soluble polymer depends on the molecular weight of the polymer, this invention can produce a water-soluble porous polymer of high viscosity by a simple and convenient process.

The water-soluble porous polymer obtained by the polymerization can be sliced or crushed in its unmodified state and put to use or can be sliced and crushed and then dried. Otherwise, it may be dried in advance and then sliced or crushed.

(5) Drying

The drying temperature to be used for the resultant hydrated water-soluble porous polymer is not particularly restricted. When the drying is performed under normal pressure, the drying temperature is in the range of 50-250° C. and more preferably 100-200° C. When the drying is carried out under a reduced pressure, the drying temperature is particularly preferably in the range from the boiling point of water under the reduced pressure to 200° C. The drying time is not particularly restricted. Properly it is in the approximate range of 10 seconds-five hours. The hydrated water-soluble porous polymer may be treated with an acid or may be neutralized with a basic substance before it is dried. Consequently, the water-soluble porous polymer may be obtained in an acid type or a neutral salt type.

The drying methods usable herein include drying in a fluidized phase, drying by heating, drying with hot air, drying under a reduced pressure, drying with an infrared ray, drying with a microwave, drying in a drum drier, dehydration by the use of an azeotrope with a hydrophobic organic solvent, and high-humidity drying by the use of steam of a high temperature, for example, though not exclusively. Among other drying methods cited above, the drying in a fluidized phase and drying with hot air prove particularly advantageous.

The water-soluble porous polymer of this invention is a porous material as implied by its name. Thus, it abounds in surface areas for contact with the ambient air and excels in drying efficiency as compared with a nonporous polymer and allows a reduction in the drying time.

Further, since this polymer also excels in the cooling efficiency for the same reason, it can curtail the cooling time after polymerization or after drying. As a result, the process which continues till disintegrating and/or crushing can be performed efficiently.

(6) Disintegrating and/or Crushing

The water-soluble porous polymer after drying or occasionally after polymerization may be disintegrated and/or crushed by a prescribed method into fragments measuring 10 μm-1000 mm, preferably 10 μm-100 mm, and particularly preferably 10 μm-10 mm. After the water-soluble porous polymer has been dried by the method described above, it has a water content of not more than 15 wt. %, more preferably not more than 10 wt. % and particularly preferably not more than 5 wt. %. This polymer may be disintegrated and/or crushed by a disintegrating and/or crushing device which fits the water content. Particularly, the water-soluble porous polymer which is obtained by the method of this invention copiously contains pores formed by the numerous bubbles in the texture of the polymer and the polymer layer forming these pores has a small thickness. By the application of the same power as used when the conventional unfoamed water-soluble polymer is disintegrated, therefore, this polymer can be disintegrated or crushed into minuter fragments. The crushing devices which are usable herein include those of impact type, compression type, and shear type. As concrete examples of the crushing device, a cutter mill, a vibration mill, a roll granulater, a knuckle type crushing device, a roll mill, a jaw crusher, a planar crusher, a shred crusher, high-speed rotary crushing devices (pin mill, hammer mill, screw mill, and roll mill), and a cylindrical mixer may be cited.

Incidentally, the water content mentioned above is found by weighing 1 g of a sample in an aluminum cup, drying the sample with a hot air drier (made by Tabai K.K.) at 130° C. for two hours, and calculating the difference in weight of the sample before and after the drying.

The second aspect of this invention is directed toward a water-soluble porous polymer obtained by polymerizing an aqueous monomer solution containing an ethylenically unsaturated monomer, which polymer has a voids ratio in the range of 5-80% based on the volume of the polymer and a water-insoluble content of not more than 10 wt. %. The water-soluble porous polymer of this quality can be produced by the method according to the first aspect of this invention. The method for the production of this polymer, however, does not need to be restricted thereto.

The water-soluble porous polymer of this invention is characterized by having, as a criterion of solubility in water, a water-insoluble content of not more than 10 wt. %, more preferably not more than 7 wt. %, and the most preferably not more than 5 wt. %. On account of the hitherto unavailability of a technique for foaming a water-soluble polymer, no water-soluble porous polymer has existed to date. This invention is capable of producing a water-soluble porous polymer by a method of production according to the first aspect of this invention. This polymer has a truly high solubility in water as compared with any of the foams existed hitherto. Specifically, the foams or the porous media which have existed hitherto have acquired such characteristic properties as low density, absorbent property, water-retaining property, heat insulating property, and sound insulating property and have been heretofore used in various fields handling building materials, audio products, horticultural products, and containers. None of them, however, possess solubility in water. The porous polymer of this invention is characterized by being soluble in water and possessing a percentage of voids in the range of 5-80%. When the polymer is manufactured in a porous texture, it acquires an enlarged surface area and an enhanced solubility in water. In the manufacture of the polymer into a thin film, the ease with which the thin film is prepared more often than not is greater when the polymer has a porous texture. The water-soluble porous polymer of this invention promises a decisively greater addition to applications as compared with the non-porous polymer.

The water-soluble porous polymer of this invention has a percentage of voids in the range of 5-80%, more preferably 10-80%, and particularly preferably 15-80%. If this percentage of voids falls short of 5%, the shortage will result in lessening the effect of enhancing the solubility in water. If it exceeds 80%, the overage will possibly degrade the strength of the powder formed by crushing. Incidentally, the percentage of voids is calculated by the method described in the preceding section (4) titled “the water-soluble porous polymer.” The term “porous” as used in this invention means the presence of voids originating in numerous bubbles in the interior of a resin and the consequent deficiency in apparent density of the resin. Incidentally, the average diameter of the pores in the water-soluble porous polymer is variable with the number of bubbles and the diameters of these bubbles. It is in the range of 3 μm-100 mm, preferably 5 μm-50 mm, and particularly preferably 10 μm-30 mm.

The third aspect of this invention is directed toward a powdered water-soluble porous polymer obtained by crushing the water-soluble porous polymer mentioned above. When the water-soluble polymer is crushed and then dissolved, as occasional demands, in an aqueous solution, the powder obtained from the porous material manifests a high solubility in water. This preference may be explained by a supposition that since the water-soluble polymer is porous before it is crushed, the surface area thereof per unit weight is proportionately exalted by the crushing. Further, the powdered water-soluble porous polymer allows more addition to the ease with which the water-soluble porous polymer mentioned above is prepared in the form of a solution. Thus, it is handled easily and conveniently when it is used in its unmodified for an agent for sewage treatment and a thickener for wallplates, for example. It occurs at times that the powdered water-soluble porous polymer obtained by crushing is devoid of a porous texture, depending on the side thereof. This invention embraces this powdered water-soluble porous polymer devoid of a porous texture in the range of the powdered water-soluble porous polymer contemplated by this invention so long as it has resulted from crushing the aforementioned water-soluble porous polymer.

The powdered water-soluble porous polymer of this invention can be prepared by disintegrating or crushing the aforementioned water-soluble porous polymer into fragments measuring about 10 μm-10 mm, more preferably about 30 μm-5 mm, and particularly preferably about 50 μm-3 mm. The extent of this crushing or disintegrating may be properly selected, depending on the water content of the water-soluble porous polymer not yet crushed. When the water content is 10 wt. %, for example, the aforementioned crushing device may be used. Particularly, the powdered water-soluble porous polmer which is obtained by the method of this invention is prepared by crushing a porous material and, by the application of the same power as used when the conventional non-porous water-soluble polymer is disintegrated, can be disintegrated or crushed into minuter fragments.

The water-soluble porous polymer has a bulk specific gravity preferably in the range of 0.1-1.2 g/ml, more preferably 0.1-1.0 g/ml, and the most preferably 0.1-0.7 g/ml. If the bulk specific gravity falls short of 0.1 g/ml, the shortage will result in unduly increasing impalpable powder and rendering difficult the handling as a powder. Conversely, if it exceeds 1.2 g/ml, the overage will result in degrading the speed of dissolution in water. Incidentally, the bulk specific gravity is found by accurately weighing 100 ml of a given powdered water-soluble porous polymer and weighing this sample.

The water-soluble porous polymer and the powdered water-soluble porous polymer of this invention do not particularly need to restrict the viscosity which they manifest when they are dissolved in a solution. The viscosity is preferably in the range of 0.001-10 Pa·s, more preferably 0.002-5 Pa·s, and particularly preferably 0.003-2 Pa·s. As stated in the foregoing section (4) titled “water-soluble porous polymer,” the scope is commended because the polymers having a viscosity falling in this range are capable of manifesting a truly outstanding effect as a flocculant and a thickener. Incidentally, the viscosiy is the numerical value determined by preparing an aqueous 0.2 wt. % solution of a given powder and measuring the aqueous solution for viscosity with a B type viscosimeter at 25° C.

The water-soluble porous polymer and the powdered water-soluble porous polymer of this invention, when necessary, may further incorporate therein deodorant, perfume, dye, hydrophilic short fibers, plasticizer, tackifier, surfactant, fertilizer, oxidizing agent, reducing agent, water, and salt so as to endow the water-soluble porous polymer and the powdered water-soluble porous polymer with various functions.

The water-soluble porous polymer and the powdered water-soluble porous polymer which are obtained by this invention can be advantageously used for such implements for medical care as laceration dressing agent, contact lens, artificial muscle, and artificial internal organs, such breeding articles as plant cultivating materials and artificial soil cultivating materials, tackifiers, agents for waste disposal, dispersants, agents for treating excavated soil, adhesive agents, concrete admixtures, carriers for immobilizing living organisms, flocculants for sewage disposal and industrial waste disposal, tackifiers for wallplates, water-retaining agents for excavation, agents for stabilizing viscosity of dispersant, water treating agents, ion sequestering agents, detergent builders, and ceramic damping agents. They can be made usable as pigments and coating materials by controlling their granularity and the shape during the course of crushing.

Now, this invention will be described more specifically below with reference to working examples and comparative examples.

### EXAMPLE 1

A vessel made of stainless steel and measuring 10 cm in inside diameter and 500 ml in inner volume was equipped with a nitrogen introducing pipe, a gas release pipe, and a silicone rubber plug fitted with a thermometer. In this vessel, 2.57 g of purified water, 58.18 g of an aqueous 37% sodium acrylate solution, and 37.73 g of acrylic acid were placed and stirred with a magnetic stirrer and the entrapped air was thoroughly displaced with nitrogen till the dissolved oxygen content fell to not more than 0.5 ppm. In this while, the stainless steel vessel was cooled with ice water to keep the inner temperature thereof to not higher than 10° C. Subsequently, 0.76 g of an aqueous 1% sodium hypophosphite solution, 0.76 g of a 1% acrylic acid solution having a photopolymerization initiator (made by Ciba Specialty Chemicals K.K. and sold under the trademark designation of “Irgacure 819”) dissolved therein, and 0.50 g of a foaming agent (made by Matsumoto Yushi Seiyaku K.K. and sold under the trademark designation of “Matsumoto Microsphere F-36”) were additionally placed and uniformly mixed to obtain a reaction solution.

This solution was fed within 5 minutes after addition of the foaming agent into a polymerization vessel made of polytetrafluoroethylene (sold under the trademark designation of “Teflon”) measuring 200 mm in diameter and displaced with nitrogen till a thickness of 3 mm and was irradiated for 3 minutes with an ultraviolet light of an intensity of 22 W/m². The peak temperature of the heat generated by the polymerization was 101° C. After the polymerization was completed, a white foam swelled to 1.4 times the volume existing when the polymerization was started was obtained. The percentage of voids in this foam was 30%. When this foam was dried with a hot air drier till the water content fell to not more than 5 wt. %, 140° C. and 10 minutes were necessary. The foam was further crushed with a bench mill at 15,700 rpm for 30 seconds to obtain a powder of 80-mesh pass in an amount of 55% of the whole amount. The bulk specific gravity of this powder was 0.32 g/ml. An aqueous 0.2 wt. % solution of this powder was prepared and was tested for viscosity with a B type viscosimeter. The viscosity was found to be 390 mPa·s. The water-insoluble content of the solution was 0.2 wt. %. An aqueous 0.1 wt. % solution of the powder was prepared and determined concentration of acrylic acid in the solution by liquid chromatography and calculated a residual acrylic acid content in the powder. This content was found to be 700 ppm.

<Percentage of Voids>

Incidentally, the percentage of voids was found by photographing the cross section of a given porous material by using a scanning type electron microscope (made by Hitachi, Ltd. and sold under the trademark designation of “SEM: S-3500N type”), calculating the total surface area of bubbles from the photograph with an image analyzing device (made by Nippon Shokubai K.K.), and calculating the percentage of voids in accordance with the following formula.
Percentage of voids (%)=100×(area of bubbles/total area analyzed)

<Water-Insoluble Content>

Then, the water-insoluble content was found by accurately weighing 0.80 g as solids of a sample, dissolving the sample in deionized water to a total amount of 400.0 g thereby preparing a 0.20 wt. % sample solution, passing the sample solution through a 250-μm sieve (JIS {Japanese Industrial Standard} Z 8801-1953) thereby withdrawing an insoluble substance of a hydrated state, and calculating the water-insoluble content in accordance with the following formula.
Insoluble content (wt. %)=100×(weight of insoluble substance (g)/400 (g))

### EXAMPLE 2

A vessel made of stainless steel and measuring 10 cm in inside diameter and 500 ml in inner volume was equipped with a nitrogen introducing pipe, an air release pipe, a thermometer, and a silicone rubber plug fitted with a pump type nozzle adapted to produce bubbles. In this vessel, 122.68 g of an aqueous 0.1 wt. %poly(sodium acrylate) solution, 135.75 g of an aqueous 37% sodium acrylate solution, 88.01 g of acrylic acid, and 4.2 g of sorbitan monostearate (made by Kao Corporation and sold under the trademark designation of “Rheodol SP-S10”) were placed and stirred with a magnetic stirrer and the entrapped air was thoroughly displaced with nitrogen till the dissolved oxygen content fell to not more than 0.5 ppm. At this time, the stainless steel vessel was cooled with ice water to keep the inner temperature thereof to not higher than 10° C. Subsequently, 1.78 g of an aqueous 1% sodium hypophosphite solution and 1.78 g of a 1% acrylic acid solution having a photopolymerization initiator (made by Ciba Specialty Chemicals K.K. and sold under the trademark designation of “Darocur 1173”) dissolved therein were additionally placed and uniformly mixed to obtain a reaction solution. This solution was fed via the pump type nozzle in the form of mousse into a polymerization vessel made of Teflon measuring 200 mm in diameter and displaced with nitrogen till a thickness of 10 mm and was immediately irradiated for 10 minutes with an ultraviolet light of an intensity of 22 W/m². The peak temperature of the heat generated by the polymerization was 92° C. After the polymerization was completed, a white mousse-like foam was obtained. The percentage of voids in this foam was 21%. When this foam was coarsely crushed with a meat chopper (made by Masuko K.K.) and dried with a hot air drier till the water content fell to not more than 5 wt. %, 140° C. and 15 minutes were necessary. The dried foam was further crushed with a bench mill at 15,700 rpm for 30 seconds to obtain a powder of 80-mesh pass in an amount of 28% of the whole amount. The bulk specific gravity of this powder was 0.41 g/ml. An aqueous 0.2 wt. % solution of this powder was prepared and was tested for viscosity with a B type viscosimeter. The viscosity was found to be 490 mPa·s. The water-insoluble content of the solution was 0.2 wt. %. An aqueous 0.1 wt. % solution of the powder was prepared and determined concentration of acrylic acid in the solution by liquid chromatography and calculated a residual acrylic acid content in the powder. This content was found to be 1,700 ppm.

### EXAMPLE 3

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 67.60 g of acrylic acid was placed and stirred with a magnetic stirrer and the entrapped air was thoroughly displaced with nitrogen till the dissolved oxygen content fell to not more than 0.5 ppm. At this time, the stainless steel vessel was cooled with ice water to keep the inner temperature thereof to not higher than 10° C. Subsequently, 0.94 g of an aqueous 1% sodium hypophosphite solution and 0.94 g of a 1% acrylic acid solution having a photopolymerization initiator (made by Ciba Specialty Chemicals K.K. and sold under the trademark designation of “Darocur 1173”) dissolved therein were additionally placed and uniformly mixed to obtain are action solution. Separately, a solution having 14.93 g of sodium carbonate dissolved in 48.25 g of purified water was prepared and displaced similarly with nitrogen. These solutions were uniformly mixed and immediately fed into a polymerization vessel made of Teflon and measuring 200 mm in diameter and displaced with nitrogen till a thickness of 3.5 mm and was irradiated for 15 minutes with an ultraviolet light having an intensity of 22 w/m². The peak temperature of the heat generated by the polymerization was 108° C. After the polymerization was completed, a white foam swelled to 1.7 times the volume existing when the polymerization was started was obtained. The percentage of voids in this foam was 41%.

When this foam was dried with a hot air drier till the water content fell to not more than 5 wt. %, 140° C. and 10 minutes were necessary. The foam was further crushed with a bench mill at 15,700 rpm for 30 seconds to obtain a powder of 80-mesh pass in an amount of 39% of the whole amount. The bulk specific gravity of this powder was 0.38 g/ml. An aqueous 0.2 wt. % solution of this powder was prepared and was tested for viscosity with a B type viscosimeter. The viscosity was found to be 390 mPa·s. The water-insoluble content of the solution was 0.3 wt. %. An aqueous 0.1 wt. % solution of the powder was prepared and determined concentration of acrylic acid in the solution by liquid chromatography and calculated a residual acrylic acid content in the powdered. This content was found to be 1,900 ppm.

### COMPARATIVE EXAMPLE 1

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 122.68 g of purified water, 135.75 g of an aqueous 37% sodium acrylate solution, and 88.01 g of acrylic acid were placed and stirred with a magnetic stirrer and the entrapped air was thoroughly displaced with nitrogen till the dissolved oxygen content fell to not more than 0.5 ppm. At this time, the stainless steel vessel was cooled with ice water to keep the inner temperature thereof to not higher than 10° C. Subsequently, 1.78 g of an aqueous 1% sodium hypophosphite solution and 1.78 g of a 1% acrylic acid solution having a photopolymerization initiator (made by Ciba Specialty Chemicals K.K. and sold under the trademark designation of “Darocur 1173”) dissolved therein were additionally placed and uniformly mixed to obtain a reaction solution. This solution was transferred via a Teflon tube into a polymerization vessel made of Teflon and measuring 200 mm in diameter and displaced with nitrogen till a thickness of 10 mm and was irradiated for 30 minutes with an ultraviolet light of an intensity of 22 W/m². The peak temperature of the heat generated by the polymerization was 88° C. After the polymerization was completed, about 350 g of a colorless transparent gel was obtained. The percentage of voids in this foam was 0.1%. When this gel was coarsely crushed with a meat chopper (made by Masuko K.K.) and was dried with a hot air drier till the water content fell to not more than 5 wt. %, 140° C. and 90 minutes were necessary. When it was not coarsely crushed with the meat chopper, 140° C. and 180 minutes were necessary for drying it till the water content fell to not more than 5 wt. %. The dried gel was further crushed with a bench mill at 15,700 rpm for 30 seconds to obtain a powder of 80-mesh pass in an amount of 5% of the whole amount. The bulk specific gravity of this powder was 0.91 g/ml. An aqueous 0.2 wt. % solution of this powder was prepared and was tested for viscosity with a B type viscosimeter. The viscosity was found to be 490 mPa·s. The water-insoluble content of the solution was 0.2 wt. %. An aqueous 0.1 wt. % solution of the powder was prepared and determined concentration of acrylic acid in the solution by liquid chromatography and calculated a residual acrylic acid content in the powder. This content was found to be 4,500 ppm.

### EXAMPLE 4

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 122.68 g of purified water, 135.75 g of an aqueous 37% sodium acrylate solution, and 88.01 g of acrylic acid were placed and stirred with a magnetic stirrer and the entrapped air was thoroughly displaced with nitrogen till the dissolved oxygen content fell to not more than 0.5 ppm. At this time, the stainless steel vessel was cooled with ice water to keep the inner temperature thereof to not higher than 10° C. Subsequently, 1.78 g of an aqueous 1% sodium hypophosphite solution and 1.78 g of a 1% acrylic acid solution having a photopolymerization initiator (made by Ciba Specialty Chemicals K.K. and sold under the trademark designation of “Darocur 1173”) dissolved therein were additionally placed and uniformly mixed to obtain a reaction solution. This solution was fed into a polymerization vessel made of Teflon and measuring 200 mm in diameter and displaced with nitrogen till a thickness of 10 mm and the resultant mixture was foamed by starting nitrogen bubbling and irradiated with an ultraviolet light of an intensity of 22 W/m² for 20 minutes. The peak temperature of the heat generated by the polymerization was 85° C.

After the polymerization was completed, a white gel containing countless minute bubbles was obtained. When this gel was tested for percentage of voids, the percentage of voids was found to be 17%. When this gel was coarsely crushed with a meat chopper (made by Masuko K.K.) and dried with a hot air drier till the water content fell to not more than 5 wt. %, 140° C. and 40 minutes were necessary. The dried gel was further crushed with a bench mill at 15,700 rpm for 30 seconds to obtain a powder of 80-mesh pass in an amount of 28% of the whole amount. The bulk specific gravity of this powder was 0.59 g/ml. An aqueous 0.2 wt. % solution of this gel was prepared and was tested for viscosity with a B type viscosimeter. The viscosity was found to be 460 mPa·s. The water-insoluble content of the solution was 0.1 wt. %. An aqueous 0.1 wt. % solution of the powder was prepared and determined concentration of acrylic acid in the solution by liquid chromatography and calculated a residual acrylic acid content in the powder. This content was found to be 3,800 ppm.

### EXAMPLE 5

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 2.57 g of purified water, 58.18 g of an aqueous 37% sodium acrylate solution, and 37.73 g of acrylic acid were placed and stirred with a magnetic stirrer and the entrapped air was thoroughly displaced with nitroten till the dissolved oxygen content fell to not more than 0.5 ppm. At this time, the stainless steel vessel was cooled with ice water to keep the inner temperature thereof to not higher than 10° C. Subsequently, 0.76 g of an aqueous 1% sodium hypophosphite solution and 0.76 g of a 1% acrylic acid solution having a photopolymerization initiator (made by Ciba Specialty Chemicals K.K. and sold under the trademark designation of “Irgacure 819”) dissolved therein were additionally placed and uniformly mixed to obtain a reaction solution. This solution was fed into a polymerization vessel made of Teflon and measuring 200 mm in diameter and displaced with nitrogen till a thickness of 3 mm and was irradiated for 10 minutes with an ultraviolet light of an intensity of 30 W/m². The peak temperature of the heat generated by the polymerization was 100° C. After the polymerization was completed, a white foam swelled to 1.3 times the volume existing when the polymerization was started was obtained. The percentage of voids in this foam was 29%. When this foam was dried with a hot air drier till the water content fell to not more than 5 wt. %, 140° C. and 40 minutes were necessary. The foam was further crushed with a bench mill at 15,700 rpm for 30 seconds to obtain a powder of 80-mesh pass in an amount of 24% of the whole amount. The bulk specific gravity of this powder was 0.49 g/ml. An aqueous 0.2 wt. % solution of this powder was prepared and was tested for viscosity with a B type viscosimeter. The viscosity was found to be 350 mPa·s. The water-insoluble content of the solution was 1.2 wt. %. An aqueous 0.1 wt. % solution of the powder was prepared and determined concentration of acrylic acid in the solution by liquid chromatography and calculated a residual acrylic acid content in the powder. This content was found to be 5,600 ppm.

### EXAMPLE 6

An autoclave made of stainless steel and measuring 10 cm in inside diameter and 800 ml in inner volume was equipped with a nitrogen introducing pipe, an air release pipe, a thermometer, stirring vanes, and a pressure gauge. In this autoclave, 122.68 g of purified water, 135.75 of an aqueous 37% sodium acrylate solution, and 88.01 g of acrylic acid were placed and stirred and the entrapped air was thoroughly displaced with nitrogen till the dissolved oxygen content fell to not more than 0.5 ppm. At this time, the stainless steel autoclave was cooled with ice water to keep the inner temperature thereof to not higher than 10° C. Subsequently, 1.78 g of an aqueous 1% sodium hypophosphite solution and 1.78 g of a 1% acrylic acid solution having a photopolymerization initiator (made by Ciba Specialty Chemicals K.K. and sold under the trademark designation of “Darocur 1173”) dissolved therein were additionally placed and uniformly mixed to obtain are action solution. The system interior was sealed, made to introduce nitrogen till the inner pressure rose to 3 MPa, and retained in the ensuant state for five minutes to allow dissolution of nitrogen into the liquid phase therein. The autoclave was relieved of the pressure and, at the same time, the solution was fed into a polymerization vessel made of Teflon and measuring 200 mm in diameter and displaced with nitrogen till a thickness of 10 mm and was irradiated for 20 minutes with an ultraviolet light of an intensity of 22 W/m². The peak temperature of the heat generated by the polymerization was 94° C. After the polymerization was completed, a gel containing countless minute bubbles was obtained. The percentage of voids in this foam was 20%. When this gel was coarsely crushed with a meat chopper (made by Masuko K.K.) and dried with a hot air drier till the water content fell to not more than 5 wt. %, 140° C. and 35 minutes were necessary. The dried gel was further crushed with a bench mill at 15,700 rpm for 30 seconds to obtain a powder of 80-mesh pass in an amount of 48% of the whole amount. The bulk specific gravity of this powder was 0.49 g/ml. An aqueous 0.2 wt. % solution of this powder was prepared and was tested for viscosity with a B type viscosimeter. The viscosity was found to be 410 mPa·s. The water-insoluble content of the solution was 0.7 wt. %. An aqueous 0.1 wt. % solution of the powder was prepared and determined concentration of acrylic acid in the solution by liquid chromatography and calculated a residual acrylic acid content in the powder. This content was found to be 3,100 ppm.

### EXAMPLE 7

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 19.77 g of purified water, 12.26 g of an aqueous 37% sodium acrylate solution, 27.11 g of acrylic acid, and 9.91 g of 2-acrylamide-2-methylpropane sulfonic acid were placed and stirred with a magnetic stirrer and the entrapped air was thoroughly displaced with nitrogen till the dissolved oxygen content fell to not more than 0.5 ppm. Subsequently, 0.48 g of an aqueous 1% sodium hypophosphite solution and 0.48 g of a 1% acrylic acid solution having a photopolymerization initiator (made by Ciba Specialty Chemicals K.K. and sold under the trademark designation of “Irgacure 819”) dissolved therein and 0.1 g of a foaming agent (made by Matsumoto Yushi Seiyaku K.K and sold under the trademark designation of “Matsumoto Microsphere F-36”) were additionally placed and uniformly mixed to obtain a reaction solution. This solution was fed within 5 minutes after addition of the foaming agent into a polymerization vessel made of Teflon, measuring 200 mm in diameter, and displaced with nitrogen till a thickness of 2 mm and was irradiated for 5 minutes with an ultraviolet light of an intensity of 22 W/m². The peak temperature of the heat generated by the polymerization was 94° C. After the polymerization was completed, a white foam swelled to 1.5 times the volume existing when the polymerization was started was obtained. The percentage of voids in this foam was 33%. When this foam was dried with a hot air drier till the water content fell to not more than 5 wt. %, 140° C. and 10 minutes were necessary. The foam was further crushed with a bench mill at 15,700 rpm for 30 seconds to obtain a powder of 80-mesh pass in an amount of 48% of the whole amount. The bulk specific gravity of this powder was 0.37 g/ml. An aqueous 0.2 wt. % solution of this powder was prepared and was tested for viscosity with a B type viscosimeter. The viscosity was found to be 110 mPa·s. The water-insoluble content of the solution was 0.2 wt. %. An aqueous 0.1 wt. % solution of the powder was prepared and determined concentrations of acrylic acid and 2-acrylamide-2-methylpropane sulfonic acid by liquid chromatography and calculated a residual acrylic acid and 2-acrylamide-2-methylpropane sulfonic acid contents in the powder. This contents were found to be 2,100 ppm and 4,000 ppm respectively.

### EXAMPLE 8

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 2.37 g of purified water, 153.04 g of an aqueous 37% sodium acrylate solution, and 42.18 g of acrylic acid were placed and stirred with a magnetic stirrer and the entrapped air was thoroughly displaced with nitrogen till the dissolved oxygen content fell to less than 0.5 ppm. At this time, the stainless steel vessel was cooled with ice water to keep the inner temperature thereof to not higher than 10° C. Subsequently, 1.20 g of an aqueous 1% sodium hypophosphite solution, 1.20 g of a 1% acrylic acid solution having a photopolymerization initiator (made by Ciba Specialty Chemicals K.K. and sold under the trademark designation of “Darocur 1173”) dissolved therein, and 0.50 g of a foaming agent (made by Matsumoto Yushi Seiyaku K.K. and sold under the trademark designation of “Matsumoto Microsphere F-36”) were additionally placed and uniformly mixed to obtain a reaction solution. This solution was fed within 5 minutes after addition of the foaming agent into a polymerization vessel made of Teflon, measuring 200 mm in diameter, and displaced with nitrogen till a thickness of 5 mm and was irradiated for 5 minutes with an ultraviolet light of an intensity of 40 W/m². The peak temperature of the heat generated by the polymerization was 108° C. After the polymerization was completed, a white foam swelled to 1.6 times the volume existing when the polymerization was started was obtained. The percentage of voids in this foam was 36%. When this foam was dried with a hot air drier till the water content fell to not more than 5 wt. %, 140° C. and 8 minutes were necessary. The foam was further crushed with a bench mill at 15,700 rpm for 30 seconds to obtain a powder of 80-mesh pass in an amount of 61% of the whole amount. The bulk specific gravity of this powder was 0.32 g/ml. An aqueous 0.2 wt. % solution of this powder was prepared and was tested for viscosity with a B type viscosimeter. The viscosity was found to be 550 mPa·s. The water-insoluble content of the solution was 0.6 wt. %. An aqueous 0.1 wt. % solution of the powder was prepared and determined concentration of acrylic acid in the solution by liquid chromatography and calculated a residual acrylic acid content in the powder. This content was found to be 5,100 ppm.

### EXAMPLE 9

In a mixing device provided with beater type stirring vanes, 100 wt. parts of soil for evaluation (evaluation value: 1) was placed and stirred at 160 rpm and 0.20 wt. part of the powdered water-soluble porous polymer obtained in Example 1 was added thereto and stirred together for 150 seconds. The resultant mixture and 5 wt. parts of Portland cement (hydraulic substance made by Taiheiyo Cement K.K.) added thereto were further stirred for 20 seconds to treat the soil for evaluation. The conditions of the evaluation soil resulting from the treatment were evaluated in accordance with the standards shown in the following table. The evaluation value was 6.

<Evaluation Soil>

This was a hydrated soil formed by thoroughly mixing 5 wt. parts of Toyoura standard sand, 75 wt. parts of silt, 270 wt. parts of clay, and 350 wt. parts of tap water. The flow value of this evaluation soil was 250 mm

Standards for Evaluation of Soil

| | | Evaluation |
|---|---|---|
| Evaluation | | of condition |
| value | Condition of granulation | of granulation |
| 1 | Neither grains nor clots were | X |
| | formed. | |
| 2 | One to several large dumpling-like | X |
| | clots | |
| 3 | Clots 5-10 cm in diameter | X |
| 4 | Grains of soil 2-4 cm in diameter, | ◯ |
| | including clots 5-10 cm in diameter | |
| 5 | Granules about 2-4 cm in diameter, | ◯ |
| | accounting for about 50% of all the | |
| | grains. | |
| | Clots about 5-10 cm in diameter, | |
| | accounting for the remainder | |
| 6 | Granules about 0.5-2 cm in | ⊚ |
| | diameter, accounting for about 50% | |
| | of all the grains. | |
| | Grains about 2-4 cm in diameter, | |
| | accounting for the remainder | |

Samples winning evaluation values of 4 or over were passed and samples winning evaluation values of 3 or less were rejected. The samples winning evaluation values of 4 and 5 were fully granulated to permit easy transportation on trucks. Depending on places of use, they were usable as refilling materials. The samples winning evaluation value of 6 were usable satisfactorily for soil refilling materials.

<Method for Calculation of Flow Value>

The flow value of a soil for evaluation was found by placing a hollow cylinder measuring 55 mm in inside diameter and 55 mm in height on a table, filling the cylinder with the soil, lifting the cylinder vertically and consequently allowing the soil to spread on the table, measuring the diameter of the spread soil in two directions, and averaging these two diameters.

### EXAMPLE 10

In a mixing device provided with beater type stirring vanes, 100 wt. parts of a given soil for evaluation (evaluation value: 1) was placed and stirred at 160 rpm and 0.18 wt. part of the powdered water-soluble porous polymer obtained in Example 7 was added thereto and stirred together for 120 seconds. The resultant mixture and 5 wt. parts of portland cement (hydraulic substance made by Taiheiyo Cement K.K.) added thereto were stirred together for 20 seconds to treat the soil. The conditions of the soild after the treatment were evaluated in accordance with the standard shown in the preceding table. The evaluation value was 6.

### EXAMPLE 11

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 7.12 g of purified water, 38.54 g of an aqueous 37% sodium acrylate solution, 85.21 g of acrylic acid, 31.16 g of 2-acrylamide-2-methylpropane sulfonic acid, and 0.66 g of a dispersant (made by Kao Corporation and sold under the trademark designation of “Rheodol SP-S10V”) were placed and stirred with a magnetic stirrer and the entrapped air was thoroughly displaced with nitrogen till the dissolved oxygen content fell to not more than 0.5 ppm. Subsequently, 1.51 g of an aqueous 1% sodium hypophosphite solution, 1.51 g of a 1% acrylic acid solution having a photopolymerization initiator (made by Ciba Specialty Chemicals K.K. and sold under the trademark designation of “Irgacure 819”) dissolved therein, and 0.50 g of a foaming agent (made by Matsumoto Yushi Seiyaku K.K. and sold under the trademark designation of “Matsumoto Microsphere F-36”) were additionally placed and uniformly mixed to obtain a reaction solution.

This solution was fed into a polymerization vessel made of Teflon measuring 200 mm in diameter and displaced with nitrogen till a thickness of 5 mm and was irradiated for 4 minutes with an ultraviolet light of an intensity of 22 W/m². The peak temperature of the heat generated by the polymerization was 106° C. After the polymerization was completed, a white foam swelled to 1.3 times the volume existing when the polymerization was started was obtained. The percentage of voids in this foam was 23%. The water content of this foam was 8%. When this foam in its undried state was crushed with a bench mill at 15,700 rpm for 30 seconds to obtain a powder of 80-mesh pass in an amount of 47% of the whole amount. The bulk specific gravity of this powder was 0.38 g/ml. An aqueous 0.2 wt. % solution of this powder was prepared and was tested for viscosity with a B type viscosimeter. The viscosity was found to be 76 mPa·s. The water-insoluble content of the solution was 0.1 wt. %. An aqueous 0.1 wt. % solution of the powder was prepared and determined concentrations of acrylic acid and 2-acrylamide-2-methylpropane sulfonic acid by liquid chromatography and calculated a residual acrylic acid content and a residual 2-acrylamide-6-methylpropane sulfonic acid content in the powder. The contents were respectively found to be 4,000 ppm and 2,100 ppm.

### EXAMPLE 12

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 16.99 g of purified water, 36.13 g of an aqueous 37% sodium acrylate solution, 79.88 g of acrylic acid, 29.21 g of 2-acrylamide-2-methylpropane sulfonic acid, and 0.62 g of a dispersant (made by Kao Corporation and sold under the trademark designation of “Rheodol SP-S10V”) were placed and stirred with a magnetic stirrer and the entrapped air was thoroughly displaced with nitrogen till the dissolved oxygen content fell to not more than 0.5 ppm. Subsequently, 1.41 g of an aqueous 1% sodium hypophosphite solution, 1.41 g of a 1% acrylic acid solution having a photopolymerization initiator (made by Ciba Specialty Chemicals K.K. and sold under the trademark designation of “Irgacure 819”) dissolved therein, and 0.50 g of a foaming agent (made by Matsumoto Yushi Seiyaku K.K. and sold under the trademark designation of “Matsumoto Microsphere F-36”) were additionally placed and uniformly mixed to obtain a reaction solution.

This solution was fed into a polymerization vessel made of Teflon, measuring 200 mm in diameter, and displaced with nitrogen till a thickness of 5 mm and was irradiated for 5 minutes with an ultraviolet light of an intensity of 22 W/m². The peak temperature of the heat generated by the polymerization was 104° C. After the polymerization was completed, a white foam swelled to 1.3 times the volume existing when the polymerization was started was obtained. The percentage of voids in this foam was 21%. The water content of the foam was 13%. When this foam in an undried state was crushed with a bench mill at 15,700 rpm for 30 seconds to obtain a powder of 80-mesh pass in an amount of 41% of the whole amount. The bulk specific gravity of this powder was 0.39 g/ml. An aqueous 0.2 wt. % solution of this powder was prepared and was tested for viscosity with a B type viscosimeter. The viscosity was found to be 106 mPa·s. The water-insoluble content of the solution was 0.7 wt. %. An aqueous 0.1 wt. % solution of the powder was prepared and determined concentrations of acrylic acid and 2-acrylamide-2-methylpropane sulfonic acid in the solution by liquid chromatography and calculated a residual acrylic acid content and a residual 2-acrylamide-2-methylproppane sulfonic acid content in the powder. These contents were respectively found to be 12,000 ppm and 7,300 ppm.

### EXAMPLE 13

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 53.71 g of purified water, 67.44 g of an aqueous 37% sodium acrylate solution, 149.11 g of acrylic acid, 54.52 g of 2-acrylamide-2-methylpropane sulfonic acid, 1.16 g of a dispersant (made by Kao Corporation and sold under the trademark designation of “Rheodol SP-S10V”), and 0.99 g of a foaming agent (made by Matsumoto Yushi Seiyaku K.K. and sold under the trademark designation of “Matsumoto Micosphere F-36”) were placed and stirred with a magnetic stirrer and the entrapped air was thoroughly displaced with nitrogen at room temperature till the dissolved oxygen content fell to not more than 0.5 ppm. Subsequently, 2.63 g of an aqueous 1% sodium hypophosphite solution and 2.63 g of a 1% acrylic acid solution having a photopolymerization initiator (made by Ciba Specialty Chemicals K.K. and sold under the trademark designation of “Irgacure 819”) dissolved therein were additionally placed and uniformly mixed to obtain a reaction solution.

This solution was fed into a polymerization vessel made of Teflon, measuring 200 mm in diameter, and displaced with nitrogen till a thickness of 10 mm and was irradiated for 10 minutes with an ultraviolet light of an intensity of 22 W/m². The peak temperature of the heat generated by the polymerization was 106° C. After the polymerization was completed, a white foam swelled to 1.4 times the volume existing when the polymerization was started was obtained. The percentage of voids in this foam was 30%. When this foam in an undried state was crushed with a bench mill at 15,700 rpm for 30 seconds to obtain a powder of 80-mesh pass in an amount of 55% of the whole amount. The bulk specific gravity of this powder was 0.39 g/ml. An aqueous 0.2 wt. % solution of this powder was prepared and was tested for viscosity with a B type viscosimeter. The viscosity was found to be 121 mPa·s. The water-insoluble content of the solution was 0.9 wt. %. An aqueous 0.1 wt. % solution of the powder was prepared and determined concentrations of acrylic acid and 2-acryliamide-2-methylpropane sulfonic acid in the solution by liquid chromatography and calculated a residual acrylic acid content and a residual 2-acrylamide-2-methylpropane sulfonic acid content in the powder. These contents were respectively found to be 13,000 ppm and 5,900 ppm

### EXAMPLE 14

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 16.99 g of purified water, 36.13 g of an aqueous 37% sodium acrylate solution, 78.88 g of acrylic acid, 29.21 g of 2-acrylamide-2-methylproppane sulfonic acid, and 0.62 g of a dispersant (made by Kao Incorporation and sold under the trademark designation of “Rheodol SP-S10V) were placed and stirred with a magnetic stirrer and the entrapped air was thoroughly displaced with nitrogen till the dissolved oxygen content fell to not more than 0.5 ppm. Subsequently, 1.41 g of an aqueous 1% sodium hypophosphite solution, 1.41 g of a 1% acrylic acid solution having a photopolymerization initiator (made by Ciba Specialty Chemicals K.K. and sold under the trademark designation of “Irgacure 819”) dissolved therein, and 0.50 g of a foaming agent (made by Matsumoto Yushi Seiyaku K.K. Aand sold under the trademark designation of “Matsumoto Microsphere F-36”) were additionally placed and uniformly mixed to obtain a reaction solution.

This solution was fed into a polymerization vessel made of Teflon measuring 200 mm in diameter till a thickness of 5 mm and was irradiated for 5 minutes with an ultraviolet light of an intensity of 22 W/m². The peak temperature of the heat generated by the polymerization was 98° C. After the polymerization was completed, a white foam swelled to 1.3 times the volume existing when the polymerization was started was obtained. The percentage of voids in this foam was 20%. The water content of this foam was 13%. When this foam in its undried state was crushed with a bench mill at 15,700 rpm for 30 seconds to obtain a powder of 80-mesh pass in an amount of 39% of the whole amount. The bulk specific gravity of this powder was 0.39 g/ml. An aqueous 0.2 wt. % solution of this powder was prepared and was tested for viscosity with a B type viscosimeter. The viscosity was found to be 100 mPa·s. The water-insoluble content of the solution was 0.5 wt. %. An aqueous 0.1 wt. % solution of the powder was prepared and determined concentrations of acrylic acid and 2-acryliamide-2-methylpropane sulfonic acid in the solution by liquid chromatography and calculated a residual acrylic acid content and a residual 2-acrylamide-2-methylpropane sulfonic acid content in the powder. These contents were respectively found to be 19,000 ppm and 9,000 ppm.

### EXAMPLE 15

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 8.92 g of purified water, 88.64 g of an aqueous 37% sodium acrylate solution, 53.14 g of acrylic acid , 12.01 g of 2-acrylamide-2-methylpropane sulfonic acid, and 0.50 g of a dispersant (made by Kao Corporations and sold under the trademark designation of “Rheodol SP-S10V”) were placed and stirred with a magnetic stirrer and the entrapped air was thoroughly displaced with nitrogen till the dissolved oxygen content fell to not more than 0.5 ppm. Subsequently, 1.16 g of an aqueous 1% sodium hypophosphite solution, 1.16 g of a 1% acrylic acid solution having a photopolymerization initiator (made by Ciba Specialty Chemicals K.K. and sold under the trademark designation of “Irgacure 819”) dissolved therein, and 0.50 g of a foaming agent (made by Matsumoto Yushi Seiyaku K.K. and sold under the trademark designation of “Matsumoto Microsphere F-36”) were additionally placed and uniformly mixed to obtain a reaction solution.

This solution was fed into a polymerization vessel made of Teflon and measuring 200 mm in diameter in an atmosphere of air till a thickness of 5 mm and was irradiated for 5 minutes with an ultraviolet light of an intensity of 22 W/m². The peak temperature of the heat generated by the polymerization was 101° C. After the polymerization was completed, a white foam swelled to 1.4 times the volume existing when the polymerization was started was obtained . The percentage of voids in this foam was 27%. When this foam was dried with a hot air drier till the water content fell to not more than 5 wt. %, 140° C. and 8 minutes were necessary. The foam was further crushed with a bench mill at 15,700 rpm for 30 seconds to obtain a powder of 80-mesh pass in an amount of 53% of the whole amount. The bulk specific gravity of this powder was 0.37 g/ml. An aqueous 0.2 wt. % solution of this foam was prepared and was tested for viscosity with a B type viscosimeter. The viscosity was found to be 510 mPa·s. The water-insoluble content of the solution was 0.2 wt. %. An aqueous 0.1 wt. % solution of the foam was prepared and determined concentrations of acrylic acid and 2-acryliamide-2-methylpropane sulfonic acid in the solution by liquid chromatography and calculated a residual acrylic acid content and a residual 2-acrylamide-2-methylpropane sulfonic acid content in the powder. These contents were respectively found to be 9,300 ppm and 4,700 ppm.

### EXAMPLE 16

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 5.42 g of purified water, 57.98 g of an aqueous 48% sodium hydroxide solution, 98.82 g of acrylic acid, and 1.16 g of a dispersant (made by Kao Corporations and sold under the trademark designation of “Rheodol SP-S10V”) were placed and stirred with a magnetic stirrer and the entrapped air was thoroughly displaced with nitrogen at room temperature till the dissolved oxygen content fell to not more than 0.5 ppm. Subsequently, 1.39 g of an aqueous 1% sodium hypophosphite solution, 1.39 g of a 1% acrylic acid solution having a photopolymerization initiator (made by Ciba Specialty Chemicals K.K. and sold under the trademark designation of “Darocur 1173”) dissolved therein, and 0.17 g of a foaming agent (made by Matsumoto Yushi Seiyaku K.K. and sold under the trademark designation of “Matsumoto Microsphere F-36”) were additionally placed and uniformly mixed to obtain a reaction solution.

This solution was fed into a polymerization vessel made of Teflon, measuring 200 mm in diameter, and displaced with nitrogen till a thickness of 5 mm and was irradiated for 5 minutes with an ultraviolet light of an intensity of 22 W/m². The peak temperature of the heat generated by the polymerization was 108° C. After the polymerization was completed, a white foam swelled to 1.5 times the volume existing when the polymerization was started was obtained. The percentage of voids in this foam was 31%. The water content of this foam was 14%. When this foam in an undried state was crushed with a bench mill at 15,700 rpm for 30 seconds to obtain a powder of 80-mesh pass in an amount of 28% of the whole amount. The bulk specific gravity of this powder was 0.37 g/ml. An aqueous 0.2 wt. % solution of this powder was prepared and was tested for viscosity with a B type viscosimeter. The viscosity was found to be 572 mPa·s. The water-insoluble content of the solution was 0.4 wt. %. An aqueous 0.1 wt. % solution of the powder was prepared and determined concentration of acrylic acid in the solution by liquid chromatography and calculated a residual acrylic acid content in the powder. This content was found to be 8,800 ppm.

### EXAMPLE 17

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 39.51 g of purified water, 122.05 g of acrylic acid, and 1.17 g of a dispersant (made by Kao Corporations and sold under the trademark designation of Rheodol SP-S10V”) were placed and stirred with a magnetic stirrer and the entrapped air was thoroughly displaced with nitrogen at room temperature till the dissolved oxygen content fell to not more than 0.5 ppm. Subsequently, 1.72 g of an aqueous 1% sodium hypophosphite solution, 1.72 g of a 1% acrylic acid solution having a photopolymerization initiator (made by Ciba Specialty Chemicals K.K. and sold under the trademark designation of “Irgacure 819”) dissolved therein, and 0.34 g of a foaming agent (made by Matsumoto Yushi Seiyaku K.K. and sold under the trademark designation of “Matsumoto Microsphere F-36”) were additionally placed and uniformly mixed to obtain a reaction solution.

This solution was fed into a polymerization vessel made of Teflon, measuring 200 mm in diameter, and displaced with nitrogen till a thickness of 5 mm and was irradiated for 5 minutes with an ultraviolet light of an intensity of 22 W/m². The peak temperature of the heat generated by the polymerization was 109° C. After the polymerization was completed, a white foam swelled to 1.3 times the volume existing when the polymerization was started was obtained. The percentage of voids in this foam was 27%. The water content of this foam was 10%. When this foam in the undried state was crushed with a bench mill at 15,700 rpm for 30 seconds to obtain a powder of 80-mesh pass in an amount of 21% of the whole amount. The bulk specific gravity of this powder was 0.37 g/ml. An aqueous 0.2 wt. % solution of this powder was prepared and was tested for viscosity with a B type viscosimeter. The viscosity was found to be 11 mPa·s. The water-insoluble content of the solution was 0.9 wt. %. An aqueous 0.1 wt. % solution of the powder was prepared and determined concentration of acrylic acid in the solution by liquid chromatography and calculated a residual acrylic acid content in the powder. This content was found to be 9,900 ppm.

### EXAMPLE 18

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 16.99 g of purified water, 36.13 g of an aqueous 37% sodium acrylate solution, 79.88 g of acrylic acid, 29.21 g of 2-acrylamide-2-methylpropane sulfonic acid, and 0.62 g of a dispersant (made by Kao Corporations and sold under the trademark designation of “Rheodol SP-S10V”) were placed and stirred with a magnetic stirrer and the entrapped air was thoroughly displaced with nitrogen at room temperature till the dissolved oxygen content fell to not more than 0.5 ppm. Subsequently, 1.41 g of an aqueous 1% sodium hypophosphite solution, 1.41 g of a 1% aqueous solution having an azo type polymerization initiator (made by Wako Pure Chemical Industries, Ltd. and sold under the product code of “V-50”), and 0.50 g of a foaming agent (made by Matsumoto Yushi Seiyaku K.K. and sold under the trademark designation of “Matsumoto Microsphere F-36”) were additionally placed and uniformly mixed to obtain a reaction solution.

This solution was fed into a polymerization vessel made of Teflon, measuring 200 mm in diameter till a thickness of 5 mm and was irradiated for 5 minutes in an atmosphere of air with an ultraviolet light of an intensity of 22 W/m². The peak temperature of the heat generated by the polymerization was 103° C. After the polymerization was completed, a white foam swelled to 1.4 times the volume existing when the polymerization was started was obtained. The percentage of voids in this foam was 27%. The water content of the foam was 12%. When this foam in the undried state was crushed with a bench mill at 15,700 rpm for 30 seconds to obtain a powder of 80-mesh pass in an amount of 31% of the whole amount. The bulk specific gravity of this powder was 0.37 g/ml. An aqueous 0.2 wt. % solution of this powder was prepared and was tested for viscosity with a B type viscosimeter. The viscosity was found to be 94 mPa·s. The water-insoluble content of the solution was 0.7 wt. %. An aqueous 0.1 wt. % solution of the powder was prepared and determined concentrations of acrylic acid and 2-acrylamide-2-methylpropane sulfonic acid in the solution by liquid chromatography and calculated a residual acrylic acid content and a residual 2-acrylamide-2-methylpropane sulfonic acid content in the powder. These contents were respectively found to be 10,000 ppm and 6,600 ppm.

### EXAMPLE 19

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 16.99 g of purified water, 36.13 g of an aqueous 37% sodium acrylate solution, 79.88 g of acrylic acid, 29.21 g of 2-acrylamide-2-methylpropane sulfonic acid, and 0.62 g of a dispersant (made by Kao Corporations and sold under the trademark designation of “Rheodol SP-S10V”) were placed and stirred with a magnetic stirrer and the entrapped air was thoroughly displaced with nitrogen till the dissolved oxygen content fell to not more than 0.5 ppm. Subsequently, 1.41 g of an aqueous 1% sodium hypophosphite solution, 0.70 g of a 1% acrylic acid solution having a photopolymerization initiator (made by Ciba Specialty Chemicals K.K. and sold under the trademark designation of “Irgacure 819”) dissolved therein, 0.70 g of an aqueous 1% solution having a thermal polymerization initiating agent (made by Wako Pure Chemical Industries K.K. and sold under the product code of “V-50”), and 0.50 g of a foaming agent (made by Matsumoto Yushi Seiyaku K.K. and sold under the trademark designation of “Matsumoto Microsphere F-36”) were additionally placed and uniformly mixed to obtain a reaction solution.

This solution was fed into a polymerization vessel made of Teflon, measuring 200 mm in diameter in a thickness of 5 mm and was irradiated for 4 minutes with an ultraviolet light of an intensity of 22 W/m². The peak temperature of the heat generated by the polymerization was 105° C. After the polymerization was completed, a white foam swelled to 1.5 times the volume existing when the polymerization was started was obtained. The percentage of voids in this foam was 35%. The water content of this foam was 11%. When this foam in the undried state was crushed with a bench mill at 15,700 rpm for 30 seconds to obtain a powder of 80-mesh pass in an amount of 41% of the whole amount. The bulk specific gravity of this powder was 0.35 g/ml. An aqueous 0.2 wt. % solution of this foam was prepared and was tested for viscosity with a B type viscosimeter. The viscosity was found to be 108 mPa·s. The water-insoluble content of the solution was 0.5 wt. %. An aqueous 0.1 wt. % solution of the powder was prepared and determined concentrations of acrylic acid and 2-acrylamide-2-methyl propane sulfonic acid in the solution by liquid chromatography and calculated a residual acrylic acid content and a residual 2-acrylamide-2-methylpropane sulfonic acid content in the powder. These contents were respectively found to be 4,100 ppm and 3,800 ppm.

### COMPARATIVE EXAMPLE 2

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 67.60 g of acrylic acid, 48.25 g of purified water, and 14.93 g of sodium carbonate were placed and stirred with a magnetic stirrer and the entrapped air was thoroughly displaced with nitrogen at room temperature till the dissolved oxygen content fell to not more than 0.5 ppm. Subsequently, 0.94 g of an aqueous 1% sodium hypophosphite solution and 0.94 g of a 1% acrylic acid solution having a photopolymerization initiator (made by Ciba Specialty Chemicals K.K. and sold under the trademark designation of “Darocur 1173”) dissolved therein were additionally placed and uniformly mixed to obtain a reaction solution. In the vessel, this reaction solution was left standing as shielded from light for 3 hours while the entrapped air was displaced with nitrogen. During the first period of about 10 minutes, the reaction solution violently effervesced because of the reaction between acrylic acid and sodium carbonate. Thereafter, no effervescence was observed. The resultant reaction solution was fed into a polymerization vessel made of Teflon, measuring 200 mm in diameter, and displaced with nitrogen till a thickness of 3.5 mm and was irradiated for 20 minutes with an ultraviolet light of an intensity of 22 W/m². In this while, absolutely no effervescence was observed. The peak temperature of the heat generated by the polymerization was 107° C. After the polymerization was completed, a colorless transparent gel containing no air bubble was obtained. The percentage of voids in this foam was 0%. When this gel was coarsely crushed with a meat chopper (made by Masuko K.K.) and dried with a hot air drier till the water content fell to not more than 5 wt. %, 140° C. and 90 minutes were necessary. When the gel was not coarsely crushed with the meat chopper, the drying performed till the water content fell to not more than 5 wt. % required 140° C. and 195 minutes. The gel was further crushed with a bench mill at 15,700 rpm for 30 seconds to obtain a powder of 80-mesh pass in an amount of 5% of the whole amount. The bulk specific gravity of this gel was 0.93 g/ml. An aqueous 0.2 wt. % solution of this powder was prepared and was tested for viscosity with a B type viscosimeter. The viscosity was found to be 440 mPa·s. The water-insoluble content of the solution was 3.1 wt. %. An aqueous 0.1 wt. % solution of the powder was prepared and determined concentration of acrylic acid in the solution by liquid chromatography and calculated a residual acrylic acid content in the powder. This content was found to be 11,500 ppm.

### EXAMPLE 20

A vessel made of stainless steel and measuring 5 cm in inside diameter and 250 ml in inner volume was equipped with a nitrogen introducing pipe, an air release pipe, and a silicone rubber plug fitted with a thermometer. In this vessel, 33.00 g of purified water, 110.08 g of methoxypolyethylene glycol (average addition mol number of ethylene oxide 25 mols), 21.92 g of methacrylic acid, 1.45 g of mercaptopropionic acid, and 1.52 g of a photopolymerizaation initiator (made by Ciba Specialty Chemicals K. K. and sold under the trademark designation of “Darocur 1173”) were placed, and stirred with a magnetic stirrer as shielded from light and the entrapped air was thoroughly displaced with nitrogn till the dissolved oxygen content fell to not more than 0.5 ppm. Subsequently, 1.65 g of a foaming agent (made by Matsumoto Yushi Seiyaku K.K. and sold under the trademark designation of “Matsumoto Microsphere F-36”) was additionally placed and uniformly mixed to obtain a reaction solution.

This solution was fed within 5 minutes after the addition of the foaming agent into a polymerization vessel made of Teflon, measuring 200 mm in diameter, and displaced with nitrogen till a thickness of 5 mm and was irradiated for 3 minutes with an ultraviolet light of an intensity of 22 W/m². The peak temperature of the heat generated by the polymerization was 90° C. After the polymerization was completed, a brown foam swelled to 1.2 times the volume existing when the polymerization was started was obtained. The percentage of voids in this foam was 19%. This foam in the undried state was crushed with a bench mill at 15,700 rpm for 30 seconds to obtain a powder of 80-mesh pass in an amount of 41% of the whole amount. The bulk specific gravity of this powder was 0.39 g/ml. An aqueous 0.2 wt. % solution of this powder was prepared and was tested for viscosity with a B type viscosimeter. The viscosity was found to be 106 mPa·s. The water-insoluble content of the solution was 0.7 wt. %. An aqueous 0.1 wt. % solution of the powder was prepared and determined concentrations of acrylic acid and 2-acrylamide-2-methylpropane sulfonic acid in the solution by liquid chromatography and calculated a residual acrylic acid content and a residual 2-acrylamide-2-methylpropane sulfonic acid content in the powder. These contents were respectively found to be 12,000 ppm and 7,300 ppm.

### EXAMPLE 21

A vessel made of stainless steel and measuring 100 ml in inner volume was equipped with a nitrogen introducing pipe, an air release pipe, and a silicone rubber plug fitted with a thermometer. In this vessel, 3.39 g of purified water, 15.57 g of acrylic acid, 2.43 g of 2-acrylamide-2-methylpropane sulfonic acid, and 3.91 g of an aqueous 48% sodium hydroxide solution were placed, and stirred with a magnetic stirrer till a solution was formed, and then 0.23 g of an aqueous 0.5% sodium hypophosphite solution and 0.47 g of an aqueous 1% acrylic acid solution having a photopolymerization initiator (made by Ciga Specialty Chemicals K.K. and sold under the trademark designation of “Irgacure 819”) dissolved therein were additionally placed and uniformly mixed to obtain a reaction solution. At this time, the stainless steel vessel was cooled with ice water to keep the inner temperature thereof to not higher than 30° C. Subsequently, the vessel was given nitrogen bubbling and the dissolved oxygen in the reaction solution was thoroughly displaced with nitrogen till the dissolved oxygen content fell to not more than 0.1 ppm. At this time, the nitrogen bubbling was terminated. Within 30 seconds of terminating the nitrogen bubbling, the reaction solution was transferred into a vat made of Teflon and measuring 5.5 cm in width and 8.5 cm in length and exposed for 5 minutes to an ultraviolet light having an intensity of 22 W/m². The peak temperature of the heat generated by the polymerization was 124° C. After the polymerization was completed, a white foam swelled to 1.8 times the volume existing when the polymerization was started was obtained. The percentage of voids in this foam was 45%. An aqueous 0.2 wt. % solution of this foam was prepared and was tested for viscosity with a B type viscosimeter. The viscosity was found to be 275 mPa·s. The water-insoluble content of the solution was 0.5 wt. %. An aqueous 0.02 wt. % solution of the powder was prepared and determined concentrations of acrylic acid and 2-acrylamide-2-methylpropane sulfonic acid in the solution by liquid chromatography and calculated acrylic acid and 2-acrylamide-2-methylpropane sulfonic acid contents in the powder. These contents were found to be 8,000 ppm and 12,000 ppm respectively.

### EXAMPLE 22

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 36.5 g of 37% sodium acrylate, 63.5 g of acrylic acid, and 0.50 g of a foaming agent (made by Matsumoto Yushi Seiyaku K.K. and sold under the trademark designation of “Matsumoto Microsphere F-36”) were placed, and stirred with a magnetic stirrer, and displaced thoroughly with nitrogen till the dissolved oxygen content fell to not more than 0.5 ppm. At this time, the stainless steel vessel was cooled with ice water to keep the inner temperature thereof to not higher than 10° C. Subsequently, 0.45 g of an aqueous 45% sodium hypophosphite solution and 0.76 g of an aqueous 1% acrylic acid solution having a photopolymerization initiator (made by Ciba Specialty Chemicals K.K. and sold under the trademark designation of “Irgacure 819”) dissolved therein were additionally placed and uniformly mixed to obtain a reaction solution.

This solution was fed into a polymerization vessel made of Teflon, measuring 200 mm in diameter, and displaced with nitrogen till and irradiated for 3 minutes with an ultraviolet light of an intensity of 22 W/m². The peak temperature of the heat generated by the polymerization was 113° C. The volume of the foam was changed to 4 times the original volume before the foaming and the solid content was 87%. When this foam was dried with a hot air drier till the water content fell to not more than 5%, 140° C. and 13 minutes were necessary. The voids ratio in the dried foam was 70%. The foam was further crushed with a bench mill at 15,700 rpm for 30 seconds to obtain a powder of 80-mesh pass in an amount of 55% of the whole amount. The bulk specific gravity of this powder was 0.33 g/ml. When the resultant reaction product was tested for residual acrylic acid content in the powder by the same method as in Example 1, this content was found to be 7,000 ppm. The weight average molecular weight measured by gel permeation chromatography was 400,000.

### EXAMPLE 23

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 36.5 g of 37% sodium acrylate, 63.5 g of acrylic acid, and 0.50 g of a foaming agent (made by Matsumoto Yushi Seiyaku K.K. and sold under the trademark designation of “Matsumoto Microsphere F-36”) were placed and stirred with a magnetic stirrer and displaced thoroughly with nitrogen till the dissolved oxygen content fell to not more than 0.5 ppm. In this case, the stainless steel vessel was cooled with ice water to retain the inner temperature thereof to not higher than 10° C. Subsequently, 2.0 g of an aqueous 45% sodium phosphite solution and 0.76 g of an aqueous 1% acrylic acid solution having a photopolymerization initiator (made by Ciba Specialty Chemicals K.K. and sold under the trademark designation of “Irgacure 819”) dissolved therein were additionally placed and uniformly mixed to obtain a reaction solution.

This solution was fed into a polymerization vessel made of Teflon, measuring 200 mm in diameter, and displaced with nitrogen and was irradiated for 3 minutes with an ultraviolet light of an intensity of 22 W/m². The peak temperature of the heat generated by the polymerization was 113° C. The volume of the foam was changed to 2.2 times the original volume prior to the foaming and the solids content was 85%. When this foam was dried with a hot air drier till the water content fell to not more than 5%, 140° C. and 17 minutes were necessary. The voids ratio in the dried foam was 52%. The foam was further crushed with a bench mill at 15,700 rpm for 30 seconds to obtain a powder of 80-mesh pass in an amount of 59% of the whole amount. The bulk specific gravity of this powder was 0.34 g/ml. When the foam was tested for residual acrylic acid content in the powder by the same method as in Example 1, the result was 2,000 ppm. By the gel permeation chromatography, the polymer was found to have a weight average molecular weight of 180,000.

### EXAMPLE 24

A vessel made of stainless steel and measuring 10 cm in inside diameter and 500 ml in inner volume was equipped with a nitrogen introducing pipe, an air release pipe, and a silicone rubber plug fitted with a thermometer. In this vessel, 36.5 g of 37% sodium acrylate, 63.5 g of acrylic acid, and 0.50 g of a foaming agent (made by Matsumoto Yushi Seiyaku K.K. and sold under the trademark designation of “Matsumoto Microsphere F-36”) were placed and stirred with a magnetic stirrer and displaced thoroughly with nitrogen till the dissolved oxygen content fell to not more than 0.5 ppm. In this case, the stainless steel vessel was cooled with ice water to retain the inner temperature thereof to not higher than 10° C. Subsequently, 4.56 g of an aqueous 45% sodium phosplhite solution and 0.76 g of an aqueous 1% acrylic acid solution having a photopolymerization initiator (made by Ciba Specialty Chemicals K.K. and sold under the trademark designation of “Irgacure 819”) dissolved therein were additionally placed and uniformly mixed to obtain a reaction solution.

This solution was fed into a polymerization vessel made of Teflon, measuring 200 mm in diameter, and displaced with nitrogen and was irradiated for 3 minutes with an ultraviolet light of an intensity of 22 W/m². The peak temperature of the heat generated by the polymerization was 113° C. The volume of the foam was changed to 1.6 times the original volume prior to the foaming and the solids content was 88.8%. When this foam was dried with a hot air drier till the water content fell to not more than 5%, 140° C. and 10 minutes were necessary. The voids ratio in the dried foam was 30%. The foam was further crushed with a bench mill at 15,700 rpm for 30 seconds to obtain a powder of 80-mesh pass in an amount of 56% of the whole amount. The bulk specific gravity of this powder was 0.34 g/ml. When the foam was tested for residual acrylic acid content in the powder by the same method as in Example 1, the result was 1,500 ppm. By the gel permeation chromatography, the polymer was found to have a weight average molecular weight of 80,000.

### INDUSTRIAL APPLICABILITY

By this invention, a water-soluble porous polymer can be produced easily and conveniently. The product of this method has a small residual monomer content and assumes a porous texture and, therefore, proves useful because it excels in solubility in water.

1. A method for the production of a water-soluble porous polymer comprising a step of polymerization of an aqueous monomer solution while having bubbles contained in the monomer solution, thereby obtaining the porous polymer having a water-insoluble content of not more than 10 wt. %.

2. A method according to claim 1, wherein said monomer solution contains an ethylenically unsaturated monomer.

3. A method according to claim 1, wherein the volume of the water-soluble porous polymer after completing polymerization is 1.1-20 times the volume of said aqueous monomer solution prior to the polymerization.

4. A method according to claim 1, wherein said bubbles are generated by the addition of a foaming agent.

5. A method according to claim 1, wherein said aqueous monomer solution further contains a surfactant.

6. A method according to claim 1, wherein said bubbles are contained by the stirring and mixing of a gas.

7. A method according to claim 1, wherein said polymerization is effected in the form of thermal polymerization and/or photopolymerization.

8. A method according to claim 2, wherein said ethylenically unsaturated monomer is acrylic acid and/or a salt thereof.

9. A water-soluble porous polymer formed by polymerizing an aqueous monomer solution containing an ethylenically unsaturated monomer, which polymer has a voids ratio in the range of 5-80% based on the volume of the polymer and a water-insoluble content of not more than 10 wt. %.

10. A powdered water-soluble porous polymer obtained by crushing a water-soluble porous polymer set forth in claim 9.

11. A water-soluble porous polymer set forth in claim 9, utilized as at least one member selected from the group consisting of tackifier, waste water cleaning agent, dispersant, pigment, coating material, agent for treating excavated soil, concrete admixture, adhesive agent, carrier for immobilizing organism, flocculant for sewage disposal and industrial waste water disposal, tackifier for wall plates, water-retaining agent for excavation, stabilizer for viscosity of dispersed solution, water treating agent, ion sequestering agent, cleaner builder, and damping agent for ceramics.

12. A water-soluble porous polymer set forth in claim 10, utilized as at least one member selected from the group consisting of tackifier, waste water cleaning agent, dispersant, pigment, coating material, agent for treating excavated soil, concrete admixture, adhesive agent, carrier for immobilizing organism, flocculant for sewage disposal and industrial waste water disposal, tackifier for wall plates, water-retaining agent for excavation, stabilizer for viscosity of dispersed solution, water treating agent, ion sequestering agent, cleaner builder, and damping agent for ceramics.

13. A method according to claim 2, wherein the volume of the water-soluble porous polymer after completing polymerization is 1.1-20 times the volume of said aqueous monomer solution prior to the polymerization.

14. A method according to claim 2, wherein said bubbles are generated by the addition of a foaming agent.

15. A method according to claim 3, wherein said bubbles are generated by the addition of a foaming agent.

16. A method according to claim 13, wherein said bubbles are generated by the addition of a foaming agent.

17. A method according to claim 2, wherein said aqueous monomer solution further contains a surfactant.

18. A method according to claim 3, wherein said aqueous monomer solution further contains a surfactant.

19. A method according to claim 4, wherein said aqueous monomer solution further contains a surfactant.

20. A method according to claim 13, wherein said aqueous monomer solution further contains a surfactant.

21. A method according to claim 14, wherein said aqueous monomer solution further contains a surfactant.

22. A method according to claim 15, wherein said aqueous monomer solution further contains a surfactant.

23. A method according to claim 16, wherein said aqueous monomer solution further contains a surfactant.
